(19) United States
(12) Patent Application Publication
(10) Pub. No.: US 2023/0003987 A1
(43) Pub. Date: Jan. 5, 2023

(54) CATADIOPTRIC MICROSCOPY

(71) Applicant: Howard Hughes Medical Institute, Chevy Chase, MD (US)

(72) Inventors: Philipp Johannes Keller, Ashburn, VA (US); Daniel Arthur Flickinger, Frederick, MD (US); Benquan Wang, Ashburn, VA (US)

(21) Appl. No.: 17/779,076

(22) PCT Filed: Jun. 17, 2020
(86) PCT No.: PCT/US2020/038111

§ 371 Date: May 23, 2022

Related U.S. Application Data
(60) Provisional application No. 62/939,380, filed on Nov. 22, 2019.

(51) Int. Cl. G02B 21/04; G02B 17/08; G02B 21/36; G02B 27/00; G02B 21/33; H04N 5/225

(52) U.S. Cl. CPC G02B 21/04; G02B 17/08; G02B 21/361; G02B 27/0025; G02B 21/33; H04N 5/2254; G02B 21/26

(57) ABSTRACT

An optical microscope apparatus includes: a sample interrogation system configured to probe a sample location; and a light collection system configured to collect light output from a sample due to being probed by the sample interrogation system. The light collection system includes: a mirror positioned along an imaging axis that passes through the sample location; and an optical lens system including a plurality of optical lenses arranged along the imaging axis, at least one of the lenses being a multiplet optical lens.

### CROSS REFERENCE TO RELATED APPLICATION

This application claims the benefit of U.S. Application No. 62/939,380, filed Nov. 22, 2019 and titled CATADIOPTRIC MICROSCOPY, which is incorporated herein by reference in its entirety.

### TECHNICAL FIELD

This disclosure relates to optical or light microscopy that includes a catadioptric design.

### BACKGROUND

Light microscopy is a technique that is used for interrogating biological specimens (samples) with high spatiotemporal resolution. Light microscopes are used throughout the life sciences and their designs and capabilities can vary substantially. A light microscope includes an objective that collects light to form an image of the specimen.

### SUMMARY

In some general aspects, an imaging apparatus includes: a mirror positioned along an imaging axis that passes through a sample location within an interrogation volume; an optical lens system comprising a plurality of optical lenses arranged along the imaging axis, at least one of the optical lenses being a multiplet optical lens; and a detection system external to the interrogation volume and configured to detect light emitted from the sample location and collected by the mirror and the optical lens system.

Implementations can include one or more of the following features. For example, the optical lenses of the optical lens system can be arranged so that, over every optical surface, all light rays in normal operation have a maximum exit angle in air, with respect to the lens surface normals, within a range of 35°-40°.

The detection system can image the light emitted from the sample location at the diffraction limit of the numerical aperture of the light detection system.

The imaging apparatus can also include a sample apparatus configured to maintain a sample at the sample location in the interrogation volume.

The multiplet optical lens can be a doublet or a triplet. A plurality of optical lenses can be multiplet optical lenses.

The mirror and the optical lens system can make up a light collection apparatus that is diffraction-limited and has a field of view of at least 8 millimeters, at least 10 millimeters, or at least 12 millimeters in diameter.

The monocentric mirror and the optical lens system can make up a light collection apparatus that is diffraction limited; a working distance between the sample location and an element of the optical lens system or the mirror can be at least 20 millimeters; and each of the mirror and the optical lenses in the optical lens system can be spherical. The mirror and the optical lens system can make up a light collection apparatus having a numerical aperture of at least 0.8, at least 0.9, or at least 1.0 for a field of view of at least 8 millimeters, at least 10 millimeters, or at least 12 millimeters in diameter for light emitted from the sample location having a wavelength within the range of 400-800 nanometers. The mirror and the optical lens system can make up a light collection apparatus that is diffraction-limited for light having a wavelength within the range of 500-800 nanometers at 81-90% light transmission efficiency. The mirror and the optical lens system can make up a light collection apparatus that is simultaneously achromatic across a range of wavelengths of 500-700 nanometers, a range of wavelengths of 700-800 nanometers, or a range of wavelengths of 450-500 nanometers. The mirror and the optical lens system can make up a light collection apparatus that is diffraction-limited and has an etendue of at least 100 square millimeters. The mirror and the optical lens system can make up a light collection apparatus configured to reduce field dependent aberrations to below a root mean square wavefront error of 0.09 waves.

The optical lens system can include a plurality of singlet optical lenses, a plurality of doublet optical lenses, and at least one triplet optical lens.

The mirror can be a mirror that is monocentric with an image of a surface of the sample location, and a maximum angle of incidence of a chief ray of light onto the optical surface of the mirror at a full field of view can be 2°, 3°, or 4°.

The optical lens system can include a plurality of multiplet lenses on a side of the sample location opposite the mirror and at least one singlet lens on a side of the sample location between the sample location and the mirror.

The detection system can detect the light emitted from the sample location without making any assumptions about the light.

Each of the optical lenses of the optical lens system and the mirror can be spherical. The axial positions of one or more of the optical lenses of the optical lens system can be offset to thereby adjust for aberrations caused by variations in the refractive index of a sample at the sample location.

The mirror and the optical lens system can make up a light collection apparatus configured to provide an optically accessible sample location along a direction perpendicular to the imaging axis. The light collection apparatus can have a working distance and a curvature of each of the optical lenses located on either side of a sample at the sample location that provides optical access to the sample location at a numerical aperture of at least 0.4, at least 0.5, or at least 0.6 to a surface of the sample at the sample location.

In other general aspects, an imaging apparatus is configured to image a sample. The imaging apparatus includes: a mirror positioned along an imaging axis that passes through a sample location; and an optical lens system including a plurality of optical lenses arranged along the imaging axis, at least one of the optical lenses being a multiplet optical lens. The mirror and the optical lenses in the optical lens system are located on both sides of the sample location along the imaging axis.

Implementations can include one or more of the following features. For example, the optical lenses of the optical lens system can be arranged so that light has a maximum angle of exitance, in air, over every optical surface, within a range of 35°-40°.

The multiplet optical lens can be a doublet or a triplet lens. A plurality of optical lenses can be multiplet optical lenses.

The mirror and the optical lens system can make up a light collection apparatus that is diffraction-limited and has a field of view of at least 8 millimeters, at least 10 millimeters, or at least 12 millimeters in diameter. The mirror and the optical lens system can make up a light collection apparatus that is diffraction-limited; a working distance between the sample location and any element of the optical lens system or the mirror can be at least 20 millimeters (mm); and each of the mirror and the optical lenses in the optical lens system can be spherical. The mirror and the optical lens system can make up a light collection apparatus having a numerical aperture of at least 0.8, at least 0.9, or at least 1.0 for a field of view of at least 8 millimeters, at least 10 millimeters, or at least 12 millimeters in diameter for light emitted from the sample location having a wavelength in the range of 400-800 nanometers. The mirror and the optical lens system can make up a light collection apparatus that is diffraction-limited for light having a wavelength in the range of 500-800 nanometers at 81-90% light transmission efficiency. The mirror and the optical lens system can make up a light collection apparatus that is achromatic across a range of wavelengths of 500-700 nanometers, a range of wavelengths of 700-800 nanometers, or a range of wavelengths of 450-500 nanometers. The mirror and the optical lens system can make up a light collection apparatus that is diffraction-limited and has an etendue of at least 100 square millimeters.

The optical lens system can include a plurality of singlet optical lenses, a plurality of doublet optical lenses, and at least one triplet optical lens.

The mirror can be a mirror that is monocentric with an image of a surface of the sample location, and a maximum angle of incidence of a chief ray of light onto the optical surface of the mirror at a full field of view can be 2°, 3°, or 4°.

The mirror and the optical lens system can make up a light collection apparatus configured to reduce field dependent aberrations to below a root mean square wavefront error of 0.09 waves.

The optical lens system can include a plurality of multiplet lenses on a side of the sample location opposite the mirror and at least one singlet lens on a side of the sample location between the sample location and the mirror.

Each of the optical lenses of the optical lens system and the mirror can be spherical.

The axial positions of one or more of the optical lenses of the optical lens system can be offset to thereby adjust for aberrations caused by variations in the refractive index of a sample at the sample location.

The mirror and the optical lens system can make up a light collection apparatus configured to provide an optically accessible sample location along a direction perpendicular to the imaging axis. The light collection apparatus can have a working distance and a curvature of each of the optical lenses located on either side of a sample at the sample location that provides optical access to the sample location at a numerical aperture of at least 0.4, at least 0.5, or at least 0.6 to a surface of the sample at the sample location.

In other general aspects, a detection apparatus is configured for imaging a sample. The detection apparatus includes: a mirror positioned along an imaging axis that passes through a sample location; an optical lens system including a plurality of optical lenses arranged along the imaging axis, at least one of the optical lenses being a multiplet optical lens; and a sample apparatus configured to define an interrogation volume and receive the sample at the sample location within the interrogation volume. The sample apparatus includes an immersion fluid at least partly contained by one or more optical lenses of the optical lens system. The mirror and the optical lenses in the optical lens system are located on both sides of the sample location.

Implementations can include one or more of the following features. For example, the immersion fluid can have a refractive index between 1.0 and 1.7. The immersion fluid and the sample placed at the sample location can have the same refractive index.

The optical lenses of the optical lens system can be arranged so that light has a maximum angle of exitance, in air, over every optical surface, within a range of 35°-40°.

The multiplet optical lens can be a doublet or a triplet lens. A plurality of optical lenses can be multiplet optical lenses.

The mirror and the optical lens system can make up a light collection apparatus that is diffraction-limited and has a field of view of at least 8 millimeters, at least 10 millimeters, or at least 12 millimeters in diameter. The mirror and the optical lens system can make up a light collection apparatus that is diffraction-limited; a working distance between the sample location and any element of the optical lens system or the mirror can be at least 20 millimeters (mm); and each of the mirror and the optical lenses in the optical lens system can be spherical.

The mirror and the optical lens system can make up a light collection apparatus having a numerical aperture of at least 0.8, at least 0.9, or at least 1.0 for a field of view of at least 8 millimeters, at least 10 millimeters, or at least 12 millimeters in diameter for light emitted from the sample location having a wavelength in the range of 400-800 nanometers. The mirror and the optical lens system can make up a light collection apparatus that is diffraction-limited for light having a wavelength in the range of 500-800 nanometers at 81-90% light transmission efficiency. The mirror and the optical lens system can make up a light collection apparatus that is achromatic across a range of wavelengths of 500-700 nanometers, a range of wavelengths of 700-800 nanometers, or a range of wavelengths of 450-500 nanometers.

The mirror and the optical lens system can make up a light collection apparatus that is diffraction-limited and has an etendue of at least 100 square millimeters.

The optical lens system can include a plurality of singlet optical lenses, a plurality of doublet optical lenses, and at least one triplet optical lens.

The mirror can be a mirror that is monocentric with an image of a surface of the sample location, and a maximum angle of incidence of a chief ray of light onto the optical surface of the mirror at a full field of view can be 2°, 3°, or 4°.

The mirror and the optical lens system can make up a light collection apparatus configured to reduce field dependent aberrations to below a root mean square wavefront error of 0.09 waves.

The optical lens system can include a plurality of multiplet lenses on a side of the sample location opposite the mirror and at least one singlet lens on a side of the sample location between the sample location and the mirror.

Each of the optical lenses of the optical lens system and the mirror can be spherical.

The axial positions of one or more of the optical lenses of the optical lens system can be offset to thereby adjust for aberrations caused by variations in the refractive index of a sample at the sample location.

The sample apparatus can further include one or more translation stages and rotation stages configured to translate and/or rotate a sample at the sample location.

The mirror and the optical lens system can make up a light collection apparatus configured to provide an optically accessible sample location along a direction perpendicular to the imaging axis. The light collection apparatus can have a working distance and a curvature of each of the optical lenses located on either side of a sample at the sample location that provides optical access to the sample location at a numerical aperture of at least 0.4, at least 0.5, or at least 0.6 to a surface of the sample at the sample location.

In other general aspects, an optical microscope apparatus includes: a sample interrogation system configured to probe a sample location; and a light collection system configured to collect light output from a sample due to being probed by the sample interrogation system. The light collection system includes: a mirror positioned along an imaging axis that passes through the sample location; and an optical lens system including a plurality of optical lenses arranged along the imaging axis, at least one of the lenses being a multiplet optical lens.

Implementations can include one or more of the following features. For example, the sample interrogation system can produce a plurality of excitation light beams directed toward the sample location. The sample interrogation system can be an optical interrogation system configured to produce one or more light beams directed toward the sample location. The one or more light beams produced by the optical interrogation system can be directed toward the sample location by way of the mirror. The one or more light beams produced by the optical interrogation system can be directed toward the sample location along a direction perpendicular to the imaging axis without interaction with the mirror. The optical interrogation system can have a working distance and a curvature of each of the optical lenses located on either side of a sample at the sample location that provides optical access to the sample location at a numerical aperture of at least 0.4, at least 0.5, or at least 0.6 to a surface of the sample at the sample location.

The optical microscope can also include a detection system that is configured to receive the light collected from the light collection system. The speed at which the detection system acquires data can be at least 1.0×10¹⁰ voxels per second. The detection system can image a sample with a volume of greater than 400 cubic millimeters at the sample location in a time period of less than 120 minutes at a spatial resolution of 0.3 micrometers by 0.3 micrometers by 0.5 micrometers, the detection system using Nyquist sampling.

The light collection system can be configured to collect light from a sample at the sample location, the sample having a refractive index between 1.0 and 1.7.

The light collection system can be configured to collect light from a sample at the sample location, the sample having a physical volume greater than 400 cubic millimeters or a surface area greater than 400 square millimeters.

The optical microscope apparatus can also include a control system in communication with the sample interrogation system and the light collection system, and configured to coordinate electrical and optical properties of the sample interrogation system and the light collection system. The optical microscope apparatus can include a detection system that is configured to receive the light collected from the light collection system. The control system can be in communication with the detection system and can be configured to form an image of a sample from the light collected from the light collection system due to the sample being probed by the sample interrogation system.

Each of the optical lenses of the optical lens system and the mirror can be spherical.

The axial positions of one or more of the optical lenses of the optical lens system can be offset from the imaging axis to thereby adjust for aberrations caused by variations in the refractive index of a sample at the sample location.

The imaging apparatus provides a diffraction-limited achromatized design (to further facilitate high-resolution light microscopy). In addition, the imaging apparatus works with a liquid immersion medium, that is, the type of medium that biological specimens used in microscopic investigations typically should be maintained in. The imaging apparatus provides a catadioptric system that incorporates one mirror and has very large numerical apertures and field sizes while still providing the degrees of freedom needed to achromatize to a significant extent (which is important for fluorescence imaging). The imaging apparatus is a catadioptric system in which a large fraction of the optical power comes from a mirror element that is at or near a monocentric condition with the image surface and system stop; that is, the chief rays are nearly normal to the surface of the mirror element. The chief rays are a set of imaging rays from all points in the object that intersect the system stop at its center, as discussed in more detail below. This serves to dramatically lessen the field-dependent aberrations that would otherwise accompany any refractive surface operating at such large etendues and optical powers. The imaging apparatus also includes non-monocentric lens elements that correct the chromatic aberrations and allow the image surface to be flat.

### DESCRIPTION OF DRAWINGS

FIG. 1 is an optical block diagram of an imaging apparatus including a light collection apparatus that is catadioptric and includes at least one reflective optical element;

FIG. 2 is an optical block diagram of a dioptric light collection apparatus that is an example of a fully monocentric imaging system;

FIG. 3 is an optical block diagram of an implementation of the imaging apparatus of FIG. 1 and including a sample apparatus and an interrogation system;

FIG. 4 is a block diagram of an optical microscope that includes an implementation of the imaging apparatus of FIG. 1 as well as a control system and an interrogation system;

FIG. 5 is a block diagram of an implementation of the interrogation system of FIG. 4 that includes a light apparatus and an optical arrangement and creates and scans a beam array of a plurality curved asymmetric Bessel-like excitation (CABLE) beams;

FIG. 6 is an optical block diagram of an implementation of the imaging apparatus of FIG. 1;

FIG. 7 is an optical block diagram of an implementation of the light collection apparatus of FIG. 1;

FIG. 8 is an optical block diagram of an implementation of the imaging apparatus of FIG. 1 and including an interrogation system;

FIG. 9A is a schematic diagram showing optical aspects of an implementation in which the interrogation system of FIG. 8 produces one or more light beams directed toward a sample location by way of the reflective optical element;

FIG. 9B is a schematic diagram showing optical aspects of an implementation in which the interrogation system of FIG. 8 produces one or more light beams directed toward a sample location without interacting with the reflective optical element;

FIG. 10 is an optical block diagram of an implementation of the light collection apparatus of FIG. 1 including an optical lens system that includes six lenses arranged relative to a sample location;

FIG. 11A is a table showing simulated bandpass filter cutoff wavelengths used and peak emission wavelengths for each fluorophore that can be present in the sample at the sample location;

FIG. 11B is a table showing refractive index and Abbe number values of different compositions of immersion fluid in which the sample location is situated;

FIG. 12A is a graph of Strehl ratios calculated under different imaging conditions, where colors correspond to different field locations: blue/light blue— 0 mm, green— 3.4 mm, red— 4.9 mm, pink— 6 mm;

FIG. 12B is a table showing conditions corresponding to configuration numbers of FIG. 12A;

FIG. 13A is a graph of Strehl ratio evaluation over larger wavelength ranges;

FIG. 13B is a table showing conditions corresponding to configuration numbers of FIG. 13A

FIG. 14A is a perspective view of an implementation of a sample apparatus configured to maintain a sample at a sample location in an interrogation volume defined in a chamber of the imaging apparatus, the sample apparatus including a sample holder in which the sample is fixed in which the sample holder holding the sample is external to the chamber;

FIG. 14B is a perspective view of the sample apparatus of FIG. 14A in which the sample holder with the sample is inserted into the chamber;

FIG. 15 is an optical block diagram of an implementation of the interrogation system of FIG. 5, the interrogation system designed to produce or create a plurality of curved light sheets as probes directed to the sample at the sample location;

FIG. 16A is an optical block diagram of an implementation of a CABLE beam generation system of the interrogation system of FIG. 15;

FIG. 16B is an optical block diagram demonstrating an implementation of a phase pattern applied to a spatial light modulator within the CABLE beam generation system of FIG. 16A;

FIG. 17 is an optical block diagram of an implementation of a beam multiplexing system of the interrogation system of FIG. 15;

FIG. 18A is an optical block diagram of an implementation of a beam manipulation system of the interrogation system of FIG. 15;

FIG. 18B is a perspective view of the beam manipulation system of FIG. 18A;

FIG. 18C is a perspective view of an implementation of a beam manipulation sub-system of the beam manipulation system of FIG. 18B;

FIG. 19 is an optical block diagram of an implementation of an illumination arrangement of the interrogation system of FIG. 15;

FIG. 20 is an optical block diagram of an implementation of the imaging apparatus of FIG. 1, showing an implementation of a detection system;

FIG. 21 is a flow chart of a procedure performed by the optical microscope of FIG. 4, using any one of the imaging apparatuses of FIGS. 1, 3, 4, 6, 7, 8 and/or the interrogation system of FIG. 4;

FIG. 22 is a table of an implementation of an optical prescription, in which labels of the optical surfaces are given in FIG. 23 and positive axial direction is toward the right; and

FIG. 23 is a simplified optical block diagram of the light collection apparatus of FIG. 10 showing the labels for the table of FIG. 22.

### DETAILED DESCRIPTION

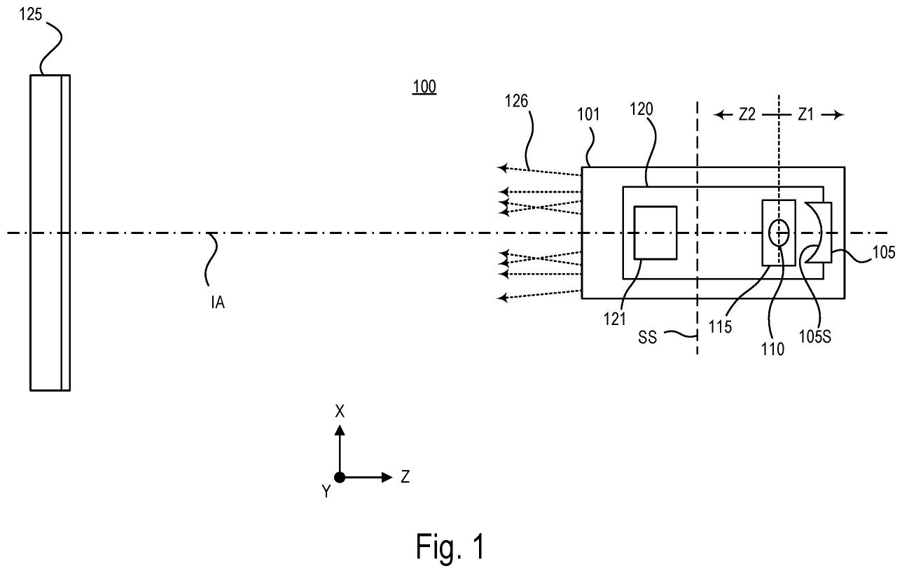

Referring to FIG. 1, an imaging apparatus 100 is shown. The imaging apparatus 100 includes a light collection apparatus 101 that is catadioptric, which means that the light collection apparatus 101 includes at least one refractive optical element and at least one reflective optical element arranged along an imaging axis IA that passes through a sample location 110 within an interrogation volume 115. Thus, the light collection apparatus 101 collects and shapes light using a catadioptric optical arrangement. The imaging axis IA extends along a Z axis of a Cartesian coordinate system X, Y, Z. The imaging apparatus 100 can be designed to be rotationally symmetric about the Z axis and extending in each of the X, Y, and Z directions. The sample location 110 is configured to receive a sample to be imaged by the imaging apparatus 100. The sample can have an extent along one or more of the X, Y, and Z directions.

The reflective optical element is a mirror 105 positioned along the imaging axis IA on a first side Z1 of the interrogation volume 115. In the following implementations, the mirror 105 has positive optical power and is converging, and thus, has a reflecting surface that curves toward the sample location 110 as it extends transversely or radially from the imaging axis IA. A large fraction (for example, most) of the positive optical power of the light collection apparatus is provided by the mirror 105. The first side Z1 of the interrogation volume 115 is the side extending along the positive Z axis away from the interrogation volume 115.

The refractive optical element is an optical lens system 120 that optically interacts with the sample location 110 and the mirror 105. The optical lens system 120 can include one or more components on the first side Z1 of the interrogation volume 115 and one or more components on a second side Z2 of the interrogation volume 115, the second side Z2 of the interrogation volume 115 being the side extending along the negative Z axis away from the interrogation volume 115. The mirror 105 and the optical lens system 120 make up a light collection apparatus 101 that is diffraction limited and has a field of view of at least 8 millimeters (mm), at least 10 mm, or at least 12 mm in diameter.

In some implementations, a working distance between the sample location 110 and any element of the optical lens system 120 or the mirror 105 is at least 20 mm. In some implementations, each of the mirror 105 and the optical lenses within the optical lens system 120 is spherical. Moreover, aspherical surfaces are not required in the light collection apparatus 101.

In various implementations, the light collection apparatus 101 has a numerical aperture (NA) of at least 0.8, at least 0.9, or at least 1.0 for a field of view (FOV) of at least 8 mm, at least 10 mm, or at least 12 mm in diameter for light emitted from the sample location 110 having a wavelength within the range of 400-800 nanometers (nm). In some implementations, the light collection apparatus 101 is diffraction limited for light having a wavelength within the range of 500-800 nm at 81-90% light transmission efficiency.

The optical lens system 120 includes a plurality of optical lenses arranged along the imaging axis IA on one or more of the first and second sides Z1, Z2. At least one of the optical lenses in the optical lens system 120 is a multiplet optical lens 121. Moreover, there can be more than one multiplet optical lens 121 in the optical lens system 120. Each multiplet optical lens 121 can be a doublet lens or a triplet lens. For example, the optical lens system 120 can include a plurality of singlet optical lenses, a plurality of doublet optical lenses, and at least one triplet optical lens, as discussed in greater detail below. The optical lenses within the optical lens system 120 can be arranged so that, over every optical surface within the system 120, all light rays in normal operation have a maximum exit angle in air, with respect to the surface normal of each lens, within a range of 30°-45° or 35°-40°.

One or more of the optical lenses in the optical lens system 120 and the mirror 105 can be movable and/or adjustable along the imaging axis IA. This axial movement of the mirror 105 and the lenses within the optical lens system 120 can be accomplished using high precision recirculating ball bearing guideways.

The imaging apparatus 100 also includes a detection system 125 external to the interrogation volume 115. The detection system 125 is configured to detect light 126 emitted from the sample location 110 and collected by the light collection apparatus 101, that is, the mirror 105 and the optical lens system 120. The light 126 can be fluorescence emitted from the sample at the sample location 110. The detection system 125 is configured to image the light 126 emitted from the sample at the sample location 110 at the diffraction limit of the numerical aperture of the light collection apparatus 101.

The imaging apparatus 100 enables high-resolution imaging of large volumes within the sample, which further enables new types of experiments and observations to be performed on the sample. For example, the imaging apparatus 100 enables rapid imaging of large, chemically cleared or expanded tissues and organs with sub-cellular resolution and without the need for physical sectioning (for example, for high-resolution structural imaging of the entire mouse brain), whole-brain live imaging of neuronal activity in large model organisms (such as the mouse), or simultaneous imaging of groups of freely behaving, interacting animals at the single-cell level (for example, for simultaneous whole-brain imaging across all individuals in a group of interacting larval zebrafish or Drosophila).

The imaging apparatus 100 avoids fundamental limitations of traditional lens objectives because it includes a catadioptric light collection apparatus 101, as described herein, for light-based image formation. Specifically, the mirror 105 replaces a traditional lens objective. Unlike a traditional lens objective, the mirror 105 can provide both high spatial resolution (by offering a high numerical aperture) and access to a large field of view. Thus, the light collection apparatus 101 achieves high performance with respect to both parameters at the same time. This is because the light collection apparatus 101 is less impacted by the scaling laws of optical aberrations and errors as etendue is increased.

Conventional scaling constraints arising from optical aberrations in traditional lens objectives can be overcome in the light collection apparatus 101, thus enabling high numerical apertures over a much larger field of view than previously possible. For example, the imaging apparatus 100 can provide a numerical aperture of 1.0 in which the sample interrogation volume 115 is water, a field of view of 12 millimeters (mm), a working distance of 25 mm, and diffraction-limited performance for 500-715 nanometers (nm) at 81-90% light transmission efficiency. Compared to state-of-the-art optics, such as the Mesolens with a numerical aperture of 0.47 and a field of view of 6 mm, the imaging apparatus 100 improves optical throughput 18-fold (quantified as the number of resolvable elements simultaneously transmitted by the apparatus 100).

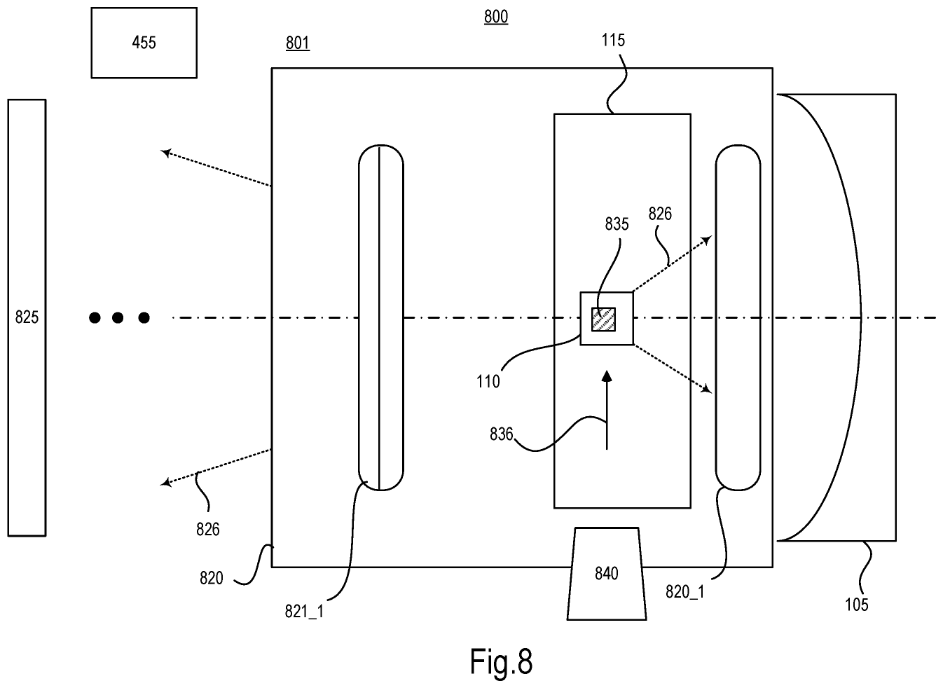

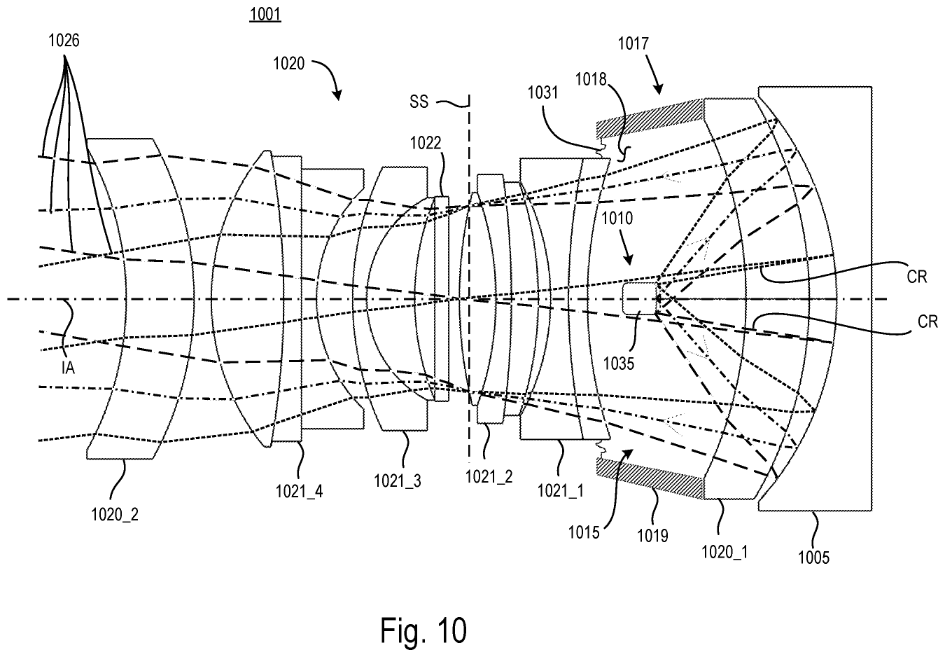

Moreover, the imaging apparatus 100 is not limited by the speed of the camera (or cameras) within the detection system 125, and because the imaging apparatus 100 has such a large-field of view, this also provides an opportunity for a dramatic speed-up in the imaging of large specimens through, for example, multiplexing of the detection process with a camera array that parallelizes image acquisition across the field of view. An implementation of the imaging apparatus 100 using a camera array consisting of 10 sCMOS cameras, offering an imaging speed of at least 1.0×10¹⁰ voxels per second or in some cases, 1.4×10¹⁰ voxels per second, is discussed below with respect to FIGS. 8 and 10.

As mentioned above, the mirror 105 provides a very large fraction of the positive optical power of the light collection apparatus 101. The mirror 105 can be monocentric, which means that it is arranged in a condition of monocentricity or near-monocentricity with the surface of the object (that is, the sample or specimen) being imaged at the sample location 110 and with the system stop SS. To put it another way, the mirror 105 can be field symmetric, which means that the set of rays that emanate from any field point in the object (sample) interact equivalently with the mirror as the set of rays coming from any other field point, or nearly field symmetric, which indicates a slight deviation from this condition. The system stop SS can be defined as the aperture stop or lens ring within the light collection apparatus 101 that physically limits the solid angle of rays (from the light 126) passing through the apparatus 101 from an on-axis object point. The system stop SS therefore limits the brightness of an image that is formed at the detection system 125 from the light 126. The system stop SS can be an aperture stop, or it can be at a surface of one of the lenses within the optical lens system 120.

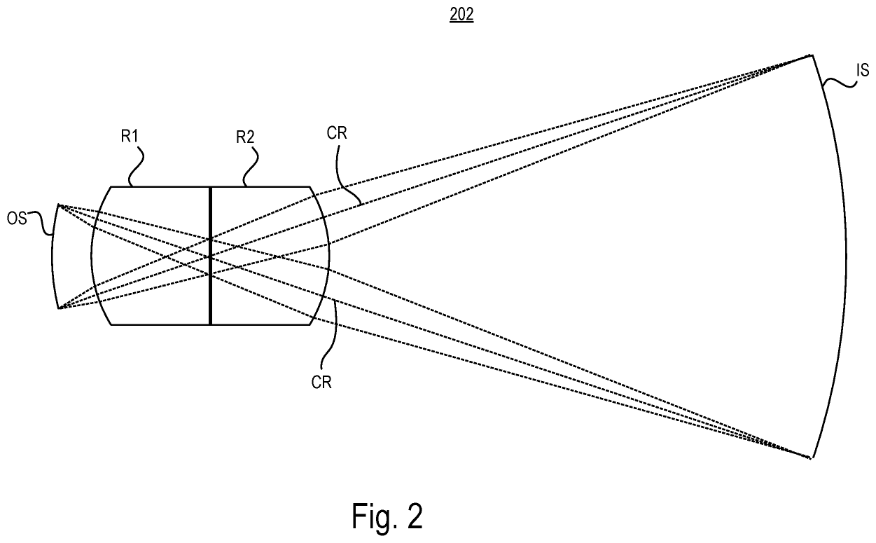

In general, a fully monocentric optical system is a system in which every optical surface, including the object and image surfaces, share a common center of curvature, located at the system stop. The light collection apparatus 101 can be a fully monocentric or nearly monocentric optical system. By way of discussion and comparison, an example of a fully monocentric imaging system that uses a dioptric light collection apparatus 202 is shown in FIG. 2. Unlike the light collection apparatus 101 of FIG. 1, the dioptric light collection apparatus 202 includes only refractive optical elements R1, R2 arranged between an object space OS and an imaging space IS. Due to the symmetry of the system with respect to the field variable, which corresponds to the fact that the chief ray CR of the system has a normal incidence on every optical surface (of each of the optical elements R1, R2), there are no field dependent aberrations of the system at all. Only spherical aberration and axial chromatic aberration can exist in such a system, and the size of the field itself is not limited in the usual way by the field-dependent aberrations, but instead is limited either by cosine foreshortening of the system stop, which gives it an effective width of zero at a 90 degree field angle, or by the overlap of optical surfaces on both sides of the stop which extend beyond being hemispheres.

One important metric of any optical system is its etendue. For a conventional optical system such as a microscope (into which the imaging apparatus 100 can be integrated), etendue is equal to the area of the field of view (FOV) times the numerical aperture (NA) available in that FOV squared. Light can propagate through an optical system with significant aberrations, and thus contribute to the simple transmission of light energy or imaging that is not diffraction limited. In light microscopy, however, where the fundamental goal is the acquisition of images of high quality and resolution of the sample (at the sample location 110), diffraction limited imaging can be important and/or needed, and thus, in calculating the etendue, only the FOV and NA that can be transmitted with correspondingly low aberrations is considered. If it is assumed that the imaging apparatus 100 is diffraction limited and the etendue in question is diffraction limited etendue, then the etendue of the imaging apparatus 100 is proportional to the number of individually resolvable image elements (resels) that can be transmitted through the apparatus 100, for a given wavelength of light.

The detection system 125 uses one or more digital image sensors (or cameras). Each sensor, or the array of sensors, can have many more pixels than the supported resels of the human eye and a conventional objective. It can therefore be advantageous to develop the light collection apparatus 101 (and the imaging apparatus 100) with a higher etendue to match the level of resolution desired at the detection system 125 for the particular sample to be imaged. The imaging apparatus 100 is designed in a manner that provides for higher etendue than would be obtained in conventional microscope objectives.

Moreover, designing an optical system in which all aberrations are held to small fractions of the wavelength of the light 126 becomes more and more difficult as the etendue is increased. Within microscope objectives that are dioptric (utilizing only light refraction at lens surfaces), and which support the large numerical aperture that is necessary for high-resolution imaging, only lens surfaces that satisfy certain narrow conditions can be utilized for the high-powered tip elements (generally the 1-4 positive meniscus lenses that contribute the majority of the positive power of the lens). For example, one condition is the aplanatic condition, and another condition is the concentric condition. In the aplanatic condition (in which the ratio of the marginal ray slope to the refractive index surrounding the ray is constant across the lens surface), significant optical surface power is possible without the introduction of any spherical aberration, coma, or astigmatism, but this is only possible if the object surface is immersed in the same index of refraction as the lens material. In the concentric condition (marginal ray has zero angle of incidence at surface), no spherical aberration or coma are introduced, but also no optical power is possible. In high-NA, dioptric microscope objectives, one or more aplanatic, or nearly-aplanatic surfaces are used in the tip elements, and usually one or more nearly-concentric surfaces are used in the tip elements as well. Although these conditions can work at a level of etendue that exceeds those of typical dioptric objectives, for example with the Mesolens at an etendue of 6.2 mm², it can be at the expense and inconvenience of significant physical up-scaling of the lens dimensions, and increased element counts.

The imaging apparatus 100 achieves a more dramatic increase in etendue without requiring unwieldy lens sizes and numbers, and thus provides an alternate, effective high etendue optical design strategy.

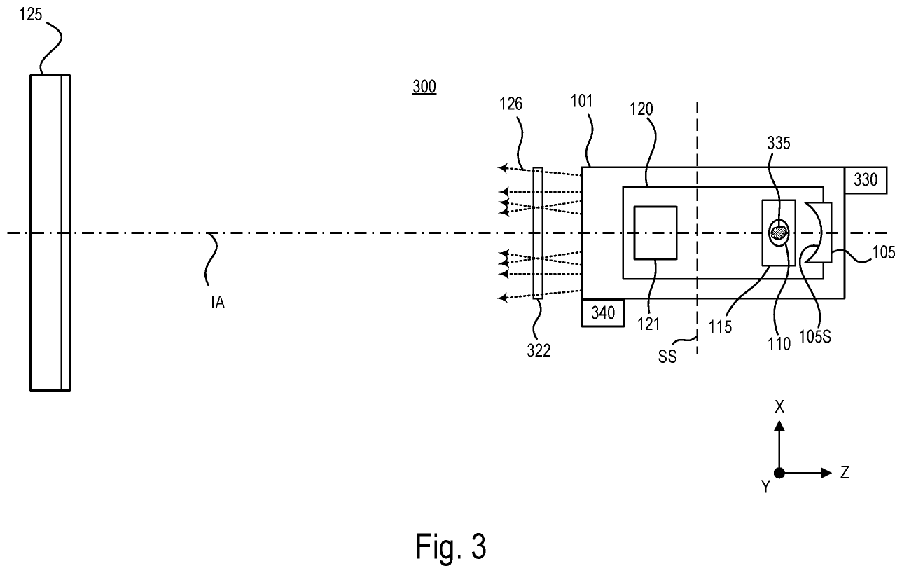

Referring to FIG. 3, in some implementations, the imaging apparatus 100 is an imaging apparatus 300 that additionally includes a sample apparatus 330 and an interrogation system 340. Each of these is described next.

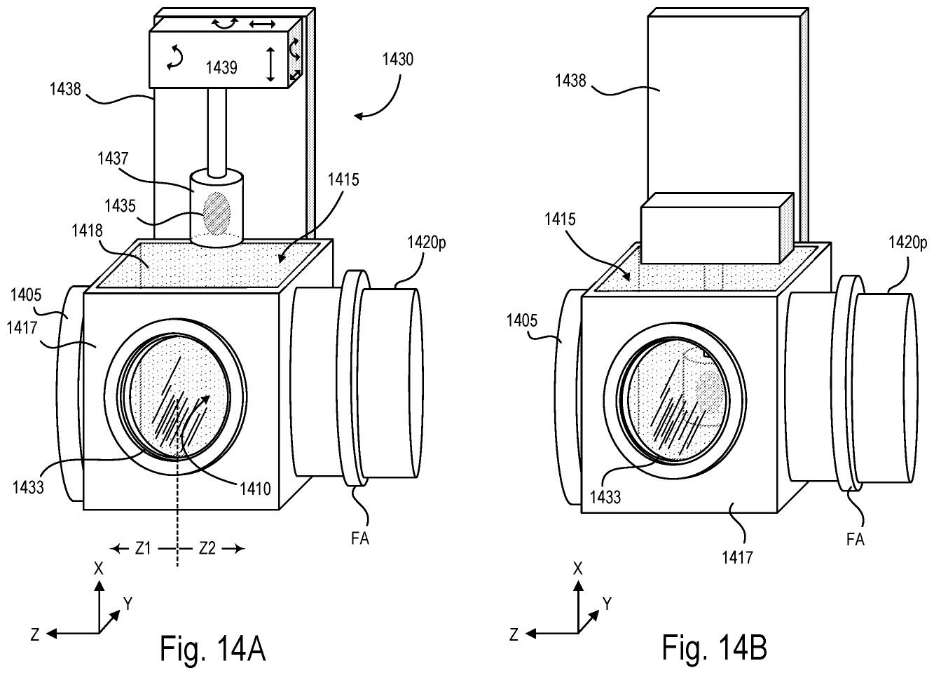

The sample apparatus 330 is configured to maintain a sample 335 at the sample location 110 in the interrogation volume 115. The sample apparatus 330 can include a holding device plus one or more translation and/or rotation stages (such as the motion stage 1439 of FIGS. 14A and 14B) that allow for translation and/or rotation of the sample 335, respectively (by translating and rotating the holding device within or into and out of the interrogation volume 115). The holding device holds the sample 335 at the sample location 110 within the interrogation volume 115. The holding device can include an immersion fluid surrounding the sample 335 or a device that both contains the sample 335 and enables the sample 335 to be imaged from different angles. An implementation of the sample apparatus 330 is described with reference to FIGS. 14A and 14B.

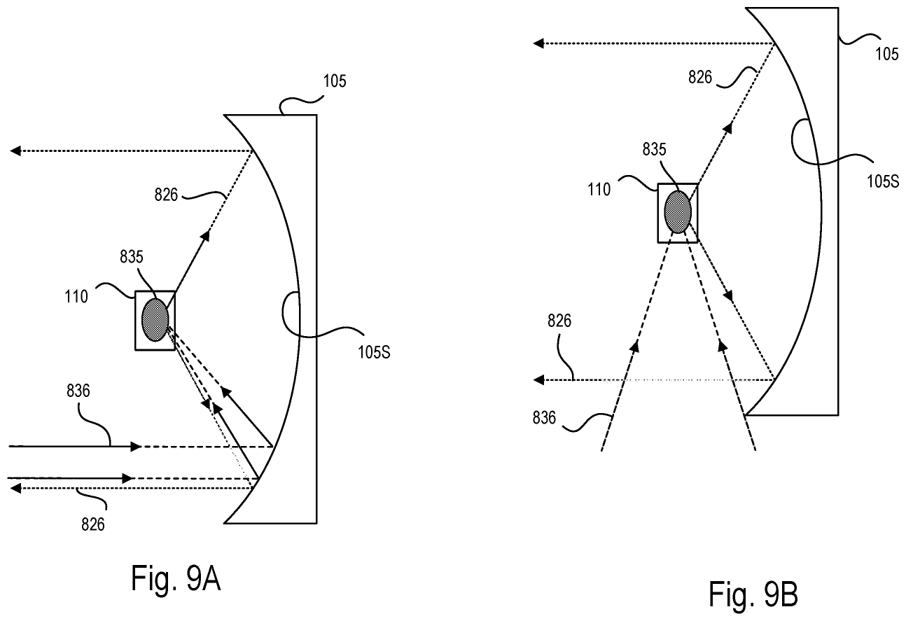

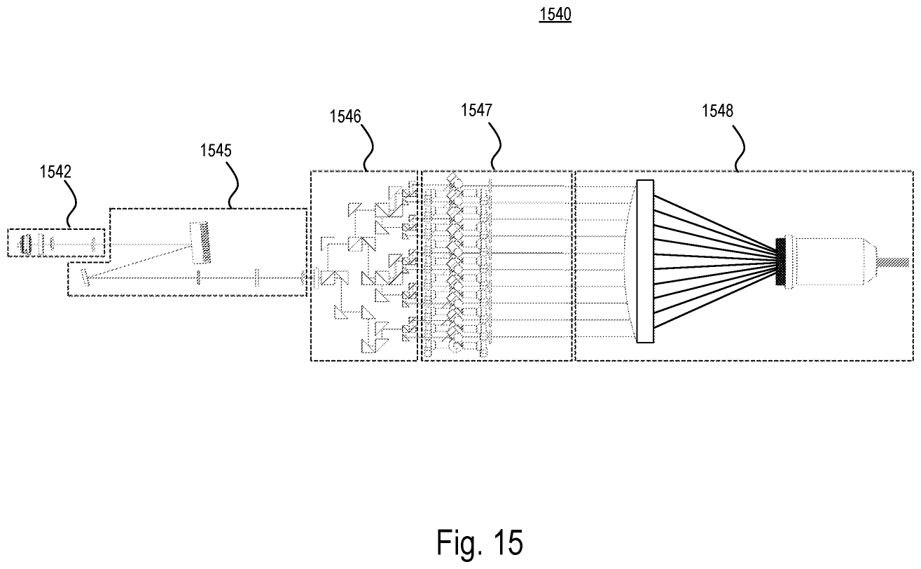

The interrogation system 340 is configured to probe the sample location 110, specifically while the sample 335 is placed at the sample location 110. In particular, the interrogation system 340 acts on and interacts with the sample 335 in a manner that causes the sample 335 to output light 126, such light 126 being collected by the light collection apparatus 101 and then detected or sensed at the detection system 125. Thus, the interrogation system 340 can produce one or more probes, such as excitation optical or light beams, directed toward the sample location. For example, wide-field illumination, light-sheet illumination, or (multi-)point-scanning can be utilized in the interrogation system 340. The implementation that uses light-sheet illumination is discussed below with reference to FIGS. 15-19. Implementations of the interrogation system 340 are described with reference to FIGS. 9A, 9B, 14A, 14B, and 15-19.

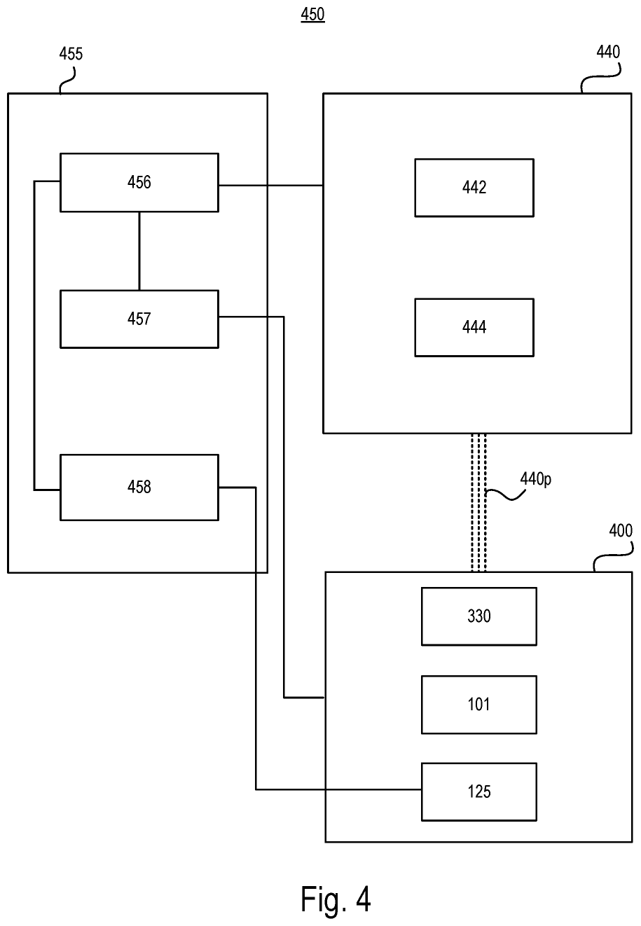

Referring to FIG. 4, the imaging apparatus 100 can be implemented as an imaging apparatus 400 within an optical microscope 450. The optical microscope 450 includes a control system 455, an interrogation system 440, and the imaging apparatus 400. The interrogation system 440 includes a light apparatus 442 and an optical arrangement 444 that produce one or more probes 440p directed toward the sample location 110 within the imaging apparatus 400.

The imaging apparatus 400 collects fluorescence light (via the light collection apparatus 101), directs this light to the cameras within the detection system 125, and translates the sample for volumetric imaging (using a sample positioning sub-system in the sample apparatus 330). The detection system 125 can include a filter wheel array FA (such as shown in FIGS. 14A and 14B) consisting of a plurality of filter wheels that each house a plurality (such as six) fluorescence filters, and a camera array consisting of a plurality of cameras (for example, sCMOS cameras such as C14120-20P, Hamamatsu, Japan) for parallelized high-speed imaging of the sample at the sample location 110. The number of filter wheels in the filter wheel array corresponds to the number of cameras in the camera array.

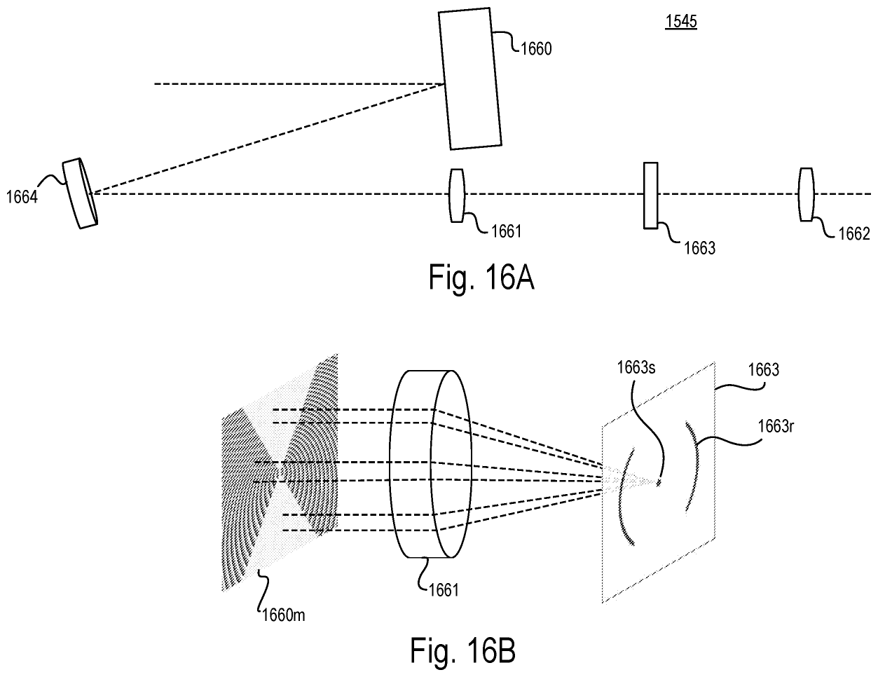

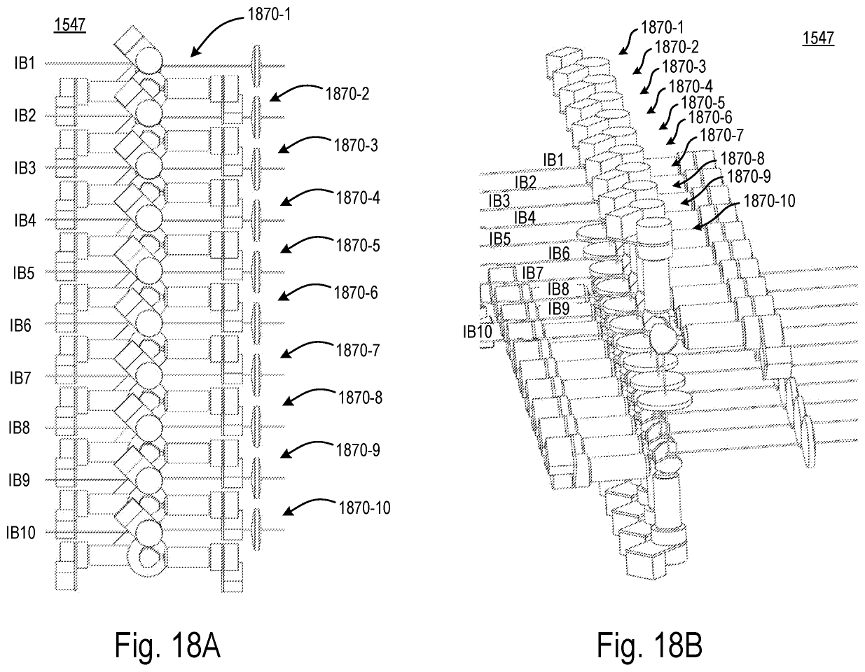

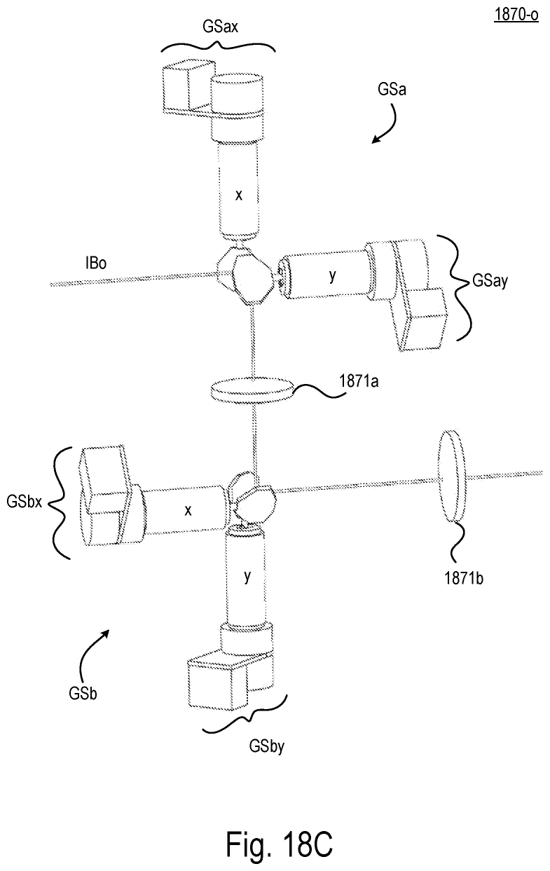

The control system 455 includes a master control apparatus 456, control electronics 457, and an image acquisition module 458. The control system operates all optical, electrical, and mechanical components of the optical microscope 450 including components within light apparatus 442 and the optical arrangement 444, and the imaging apparatus 400. For example, the control system 455 can be configured to control a spatial light modulator 1660 (FIG. 16A), galvanometer scanners GS (FIG. 18C), and translation and rotation stages within the optical arrangement 442, and filter wheels and cameras within the imaging apparatus 400.

One or more of these components of the master control apparatus 456 can include hardware such as one or more output devices (such as a monitor or a printer); one or more user input interfaces such as a keyboard, mouse, touch display, or microphone; one or more processing units; including specialized workstations for performing specific tasks; memory (such as, for example, random-access memory or read-only memory or virtual memory); and one or more storage devices such as hard disk drives, solid state drives, or optical disks. The processing units can be stand-alone processors, or can be sub-computers such as workstations in their own right. The control system 455 can have a distributed architecture in which some functions are allocated or located at one computer while other functions are allocated or located at another computer.

The master control apparatus 456 coordinates all electrical and optical parts of the optical microscope 450. The master control apparatus 456 can include a computer that runs LabVIEW control software to coordinate and control the aspects of the optical microscope 450.

In some examples, the master control apparatus 456 is a server running an operating system (such as Windows 10) and LabVIEW microscope control software. The LabVIEW software coordinates all components of the optical microscope 450 to execute the imaging workflow and ensure synchronized image acquisition. More specifically, the master control apparatus 456 sends control commands to the control electronics 457 to generate proper drive and trigger signals for the light apparatus 442 and the optical arrangement 442 of the interrogation system 440 as well as for the imaging apparatus 400. The master control apparatus 456 also sends commands to image acquisition nodes within the image acquisition module 458 (for example, by way of Ethernet) to set parameters associated with the cameras within the detection system 125, and to start and/or stop image acquisition at the detection system 125.

The image acquisition module 458 is configured to execute imaging workflow, including acquiring and saving image data from the detection system 125. The output from the image acquisition module 458 is fed to the master control apparatus 456 and the communication between the image acquisition module 458 and the master control apparatus 456 can be wired or wireless. The image acquisition module 458 can operate in a plurality of image acquisition nodes that run LabVIEW image acquisition software, each node being connected to one camera within the imaging apparatus 100 (for example, within the detection system 125) by way of a CoaXPress cable for image acquisition. For example, as discussed below with reference to FIGS. 15-19, the detection system 125 can include 10 imaging sub-systems or detectors; in this case, the image acquisition module 458 can operate in 10 image acquisition nodes. All image acquisition nodes can be connected to the master control computer (of the master control apparatus 456) by way of Ethernet communication to also receive image acquisition commands from the master control computer of the master control apparatus 456.

The image acquisition nodes are responsible for operating the respective dedicated cameras (within the detection system 125), acquiring and temporarily storing data following instructions provided by the master control apparatus 456. More specifically, the image acquisition nodes receive commands from the master control apparatus 456 to set camera parameters including exposure time, area mode, area of interest, etc., upon which the image acquisition nodes will configure each connected camera accordingly. The image acquisition nodes also receive commands from the master control apparatus 456 for starting image acquisition, and will then in turn start the acquisition process and set the cameras to wait for the start trigger signal. When the cameras receive the start trigger signal from the control electronics 457, they will commence image acquisition synchronously. The image acquisition nodes can also receive commands to interrupt an ongoing acquisition and will immediately stop the acquisition upon receiving the command.

The control electronics 457 is configured to generate and synchronize control signals for the individual components within the interrogation system 440 and the imaging apparatus 400, including, but not limited to, galvanometer scanners, filter wheels, translation stages, and cameras. The control electronics 457 includes a chassis that is connected to the master control apparatus 456, several analog input and analog output cards, as well as a serial interface card, all of which are installed in the chassis.

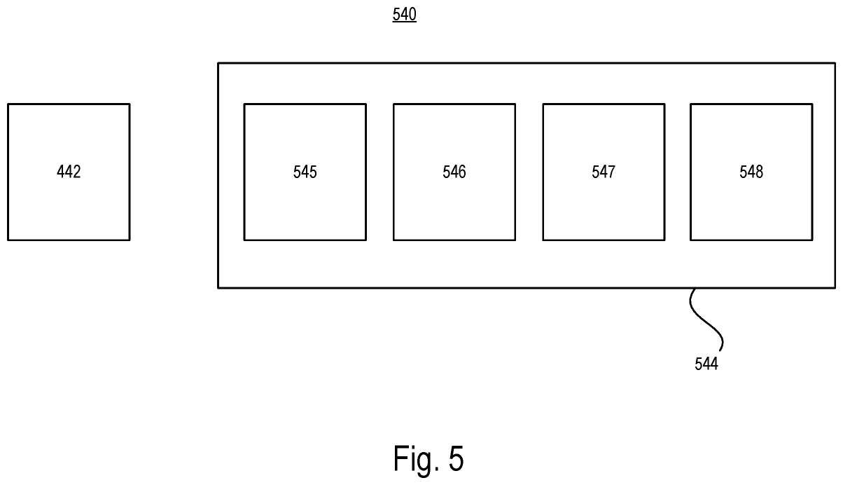

The control electronics 457 can be implemented in a chassis (for example, PXIe-1078, National Instruments) that is connected to the master control apparatus 456 by way of a remote controller card (for example, PCIe-8381, National Instruments) installed in one of the master control apparatuses 456 PCIe slots. Three data acquisition cards can be installed in the chassis: two PXIe-6738 acquisition cards (National Instruments) providing 64 analog output (AO) channels, and one PXIe-6363 acquisition card (National Instruments) providing 32 analog input (AI) channels. Operated by the master control apparatus 456, the PXIe-6738 acquisition cards generate analog voltage signals to drive the galvanometer scanners GSa, GSb in the beam manipulation system 547 (FIG. 5) and modulate laser intensity of the probes 836 (FIG. 8). They also generate TTL or LVCMOS signals to synchronize the cameras, stages and filter wheels, and enable/disable the lasers within the interrogation system 440. One serial interface card (PXIe 8430/8, National Instruments) can be installed in the chassis to provide 8 RS-232 communication ports that are used to control devices including the light apparatus 442 and motion stages.

As mentioned above, the interrogation system 440 includes the light apparatus 442 and the optical arrangement 444 that produce the one or more probes 440p directed toward the sample location 110 within the imaging apparatus 400. The field of view of the illumination optics within the interrogation system 440 is matched to the field of view of the detection optics within the imaging apparatus 400, and thus any part that can be imaged in the detection system 125 can also be illuminated in the interrogation system 440.

In some implementations, as shown in FIG. 5, the interrogation system 440 is implemented as an interrogation system 540 including the light apparatus 442 and an optical arrangement 544. The interrogation system 540 creates and scans a beam array of a plurality (such as 10) curved asymmetric Bessel-like excitation (CABLE) beams. The optical arrangement 544 includes a CABLE beam generating system 545, a beam multiplexing system 546, a beam manipulation system 547, and an illumination arrangement 548 (which can include a custom tube lens and/or objective). In other implementations, it may be possible to use Gaussian beams to create a scanned laser light sheet from the output of the light apparatus 442.

Aspects relating to the imaging apparatus 400 are discussed next, followed by a discussion of the interrogation system 540.

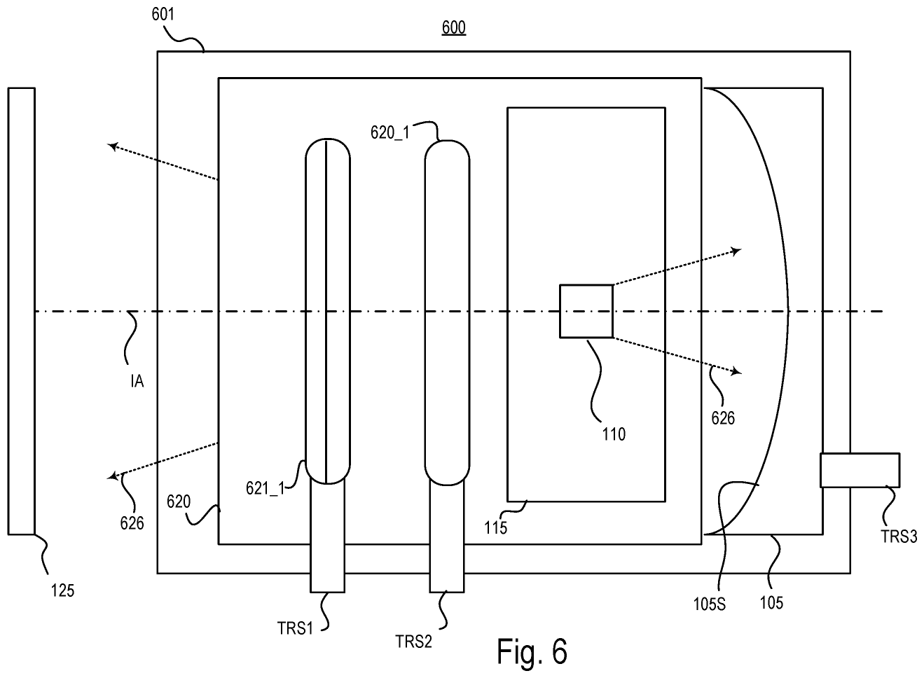

Referring to FIG. 6, an implementation 600 of the imaging apparatus 100 is shown. The imaging apparatus 600 includes an optical lens system 620 that includes a plurality of optical lenses. In this implementation, the optical lens system 620 includes only two optical lenses 620_1 and 621_1. In other implementations, the optical lens system 620 can include more than two optical lenses. The optical lenses are arranged along the imaging axis IA. At least one of the optical lenses is a multiplet optical lens. In this implementation, the lens 621_1 is represented as a multiplet lens. There can be more than one multiplet lens in the optical lens system 620. The imaging apparatus 600 also includes the detection system 125 external to the interrogation volume 115. The detection system 125 is configured to detect light 626 emitted from the sample location 110 and collected by the mirror 105 and the optical lens system 620. Some rays of light 626 are shown in short-dashes for reference.

The optical lenses of the optical lens system 620 are arranged so that, over every optical surface, all rays of light 626 in normal operation have a maximum exit angle in air, with respect to normals at the lens surface, within a range of 35°-40°, where the exit angle of the ray of light 626 is the angle that a ray of light 626 makes with the surface normal of the optical lens (such as optical lens 620_1 and 621_1) as it exits that optical lens. The multiplet optical lens 621_1 can be a doublet lens or a triplet lens.

The detection system 125 images the light 626 emitted from the sample location 110 at the diffraction limit of the numerical aperture of the imaging apparatus 100. The mirror 105 and the optical lens system 620 make up a light collection apparatus that is diffraction-limited and has a field of view of at least 8 millimeters, at least 10 millimeters, or at least 12 millimeters in diameter.

A working distance between the sample location 110 and any element of the optical lens system 620 or the mirror 105 is at least 20 millimeters (mm), and each of the mirror 105 and the optical lenses 620_1, 621_1 in the optical lens system 620 is spherical. This means that the surfaces interacting with light 626 on each of the mirror 105 and the optical lenses 620_1, 621_1 have a spherical shape. The working distance can be considered as the effective distance from the nearest optical element to the closest surface of the sample when the sample is in focus. The light collection apparatus 601 has a numerical aperture of at least 0.8, at least 0.9, or at least 1.0 for a field of view of at least 8 millimeters, at least 10 millimeters, or at least 12 millimeters in diameter for light 626 emitted from the sample location 110 having a wavelength within the range of 400-800 nanometers. The light collection apparatus 601 is diffraction-limited for light having a wavelength within the range of 500-800 nanometers at 81-90% light transmission efficiency. The light collection apparatus 601 can be simultaneously achromatic across a range of wavelengths of 500-700 nanometers, a range of wavelengths of 700-800 nanometers, or a range of wavelengths of 450-500 nanometers. The light collection apparatus 601 can have an etendue of at least 100 square millimeters.

The mirror 105 is a curved mirror having an optically-reflective surface 105S that interacts with the light 626 emitted from the sample at the sample location 110. The mirror 105 can be monocentric or nearly monocentric with an image of a surface of the sample location 110. A maximum angle of incidence of a chief ray of light (as discussed with respect to FIG. 2 and also shown in FIG. 10) onto the optical surface of the mirror 105 at a full field of view is 2°, 3°, or 4°.

The light collection apparatus 601 is configured to reduce field dependent aberrations to below a root mean square wavefront error of 0.2, 0.1, 0.09, or 0.07 waves.

The detection system 125 detects the light 626 emitted from the sample location 110 without making any assumptions about the light 626. The detection system 125 can include a plurality of detection channels, with each detection channel dedicated to detecting a specific range of wavelengths to enable multi-color detection.

The axial positions of one or more of the optical lenses 620_1, 621_1 of the optical lens system 620 can be offset from the other optical lenses and components of the light collection apparatus 601 to thereby adjust for aberrations caused by variations in, for example, the refractive index of an immersion fluid within the interrogation volume 115 or a sample at the sample location 110. An axial position of an optical lens is offset by adjusting a position of the optical lens along the imaging axis IA. In this way, the imaging apparatus 600 is configured to adapt the microscope to a new specimen at the beginning of a new experiment. For example, an immersion fluid (such as the immersion fluid 718 or the immersion fluid 1418) that is held in the interrogation volume 115 can have a slightly different chemical composition during one experiment relative to another experiment. For example, a concentration of one of the ingredients within the immersion fluid may be changed, and this change in turn changes the optical properties of the immersion fluid, which changes the optical path of the light 626. To compensate for this change in the optical path the lenses can be moved accordingly. As another example, the sample 335 can be changed from one experiment to the next or the sample 335 itself can vary along its volume in a single experiment. Optical properties can also change as a function of time; for example, if some of the water within the immersion fluid evaporates, this can lead to an increase of the concentration of some of the chemical compounds in the immersion fluid (thereby increasing the refractive index over time). The control system 455 can monitor these changes during the experiment, and can compensate for the changes during imaging.

The light collection apparatus 601 is configured to provide an optically accessible sample location 110 along a direction perpendicular to the imaging axis IA. For example, the light collection apparatus 601 has large enough working distances on both sides of the sample location 110, and the optical surfaces facing the sample location 110 (the optical surfaces of the optical lenses 620_1, 621_1 that face the sample location) have small enough curvatures to allow optical access to the sample location 110 at a numerical aperture of at least 0.4, at least 0.5, or at least 0.6.

One or more of the optical elements of the light collection apparatus 601 can be arranged on translation and/or rotation stages TRS1, TRS2, TRS3, such translation and/or stages TRS1, TRS2, TRS3 being controlled by the control electronics 457 of the control system 455 for adjusting/translating/rotating positions of such components.

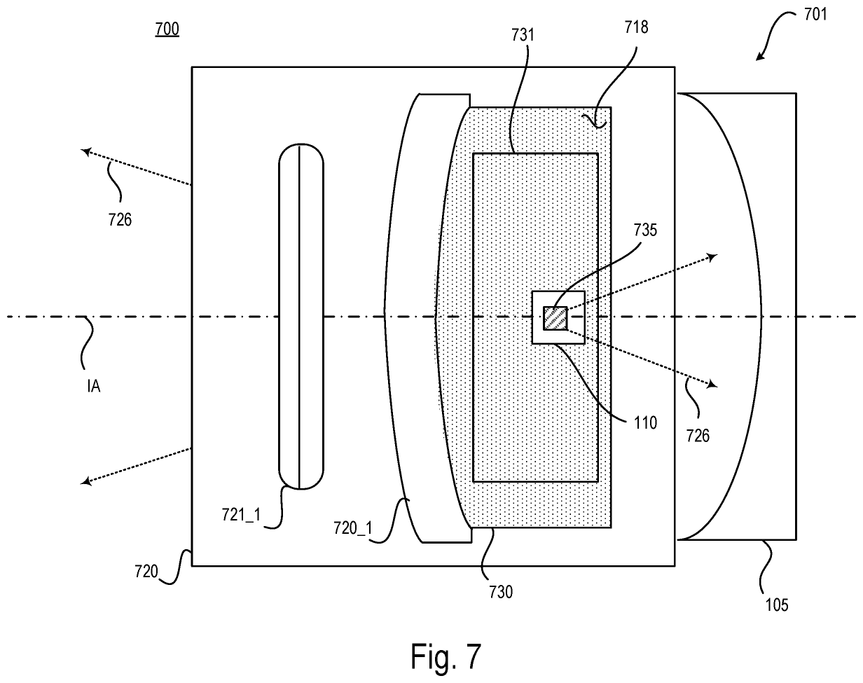

In some implementations, such as shown in FIGS. 7 and 10, the mirror 105 and the optical lenses in the optical lens system 620 can be located on both sides of the sample location 110 along the imaging axis IA.

Referring to FIG. 7, a light collection apparatus 701 that is a part of an imaging apparatus 700 is configured to image a sample 735 placed at the sample location 110 by collecting light 726 that is emitted from the sample 735 and directing that collected light toward the detection system 125. The light collection apparatus 701 includes the mirror 105 positioned along the imaging axis IA that passes through the sample location 110. The light collection apparatus 701 includes the optical lens system 720. The light collection apparatus 701 also includes a sample apparatus 730 configured to define an interrogation volume 731 and to receive the sample 735 at the sample location 110 within the interrogation volume 731. The sample apparatus 730 includes an immersion fluid 718 at least partly contained by one or more optical lenses 720_1 of the optical lens system 720. The immersion fluid 718 can have a refractive index between 1.0 and 1.7. The immersion fluid 718 and the sample 735 placed at the sample location 110 can have the same refractive index.

Referring to FIG. 8, an imaging apparatus 800 (which is a part of an optical microscope) includes an interrogation system 840 configured to probe the sample location 110. The interrogation system 840 can be configured to produce a plurality of excitation light (optical) beams directed toward the sample location 110. These excitation light beams act to excite the fluorophores or other molecules within a sample 835 in the sample location 110, and such fluorophores or other molecules emit light 826 that is collected by the imaging apparatus 800. To this end, the imaging apparatus 800 includes a light collection apparatus 801 configured to collect light 826 output from the sample 835 at the sample location 110, the light 826 that is output is the result of the sample 835 being probed by one or more probes 836 from the interrogation system 840. The light collection apparatus 801 includes, as discussed above, a mirror 105 positioned along the imaging axis IA that passes through the sample location 110 and an optical lens system 820 having a plurality of optical lenses 820_1, 821_1 arranged along the imaging axis IA.

In some implementations, the interrogation system 840 is an optical interrogation system configured to produce as the probes 836 one or more light beams directed toward the sample location 110.

In some implementations, as shown in FIG. 9A, the one or more light beams 836 produced by the interrogation system 840 are directed toward the sample 835 at the sample location 110 by way of the mirror 105. For example, the light beams 836 can be reflected off the optically-reflective surface 105S of the mirror 105, and then directed toward the sample location 110. Fluorescence 826 is emitted from the sample 835 due to the interaction between the light beams 836 and the sample 835, and the fluorescence 826 is collected by the light collection apparatus 801.

In other implementations, as shown in FIG. 9B, the one or more light beams 836 produced by the interrogation system 840 are directed toward the sample 835 at the sample location 110 along a direction that is not parallel with (for example, is perpendicular to) the imaging axis IA.

In these implementations, the light beams 836 travel to the sample location 110 without interacting with the mirror 105. Fluorescence 826 is emitted from the sample 835 due to the interaction between the light beams 836 and the sample 835, and the fluorescence 826 is collected by the light collection apparatus 801.

Referring again to FIG. 8, the imaging apparatus 800 can also include a detection system 825 such as the detection system 125 as shown in FIG. 1, the detection system 825 being configured to receive the light 826 collected from the light collection apparatus 801. The speed with which the detection system 825 acquires data can be at least 1×10¹⁰ voxels per second. The detection system 825 can image a sample 835 having a volume of greater than 100, 200, 300, or 400 cubic millimeters at the sample location 110 in a time period of less than 120 minutes at a spatial resolution as good as or better than 0.3 micrometers by 0.3 micrometers by 0.5 micrometers. The detection system 825 can use Nyquist sampling.

The control system 455 can be in communication with the interrogation system 840 and the light collection apparatus 801. The control system 455 is configured to coordinate electrical and optical properties of the interrogation system 840 and the light collection apparatus 801. The control system 455 can also be in communication with the detection system 825 and can be configured to form an image of the sample from the light 826 collected by the light collection apparatus 801 due to the sample 835 being probed by the interrogation system 840.

Referring to FIG. 10, in other implementations, a light collection apparatus 1001 is configured to image a sample 1035 placed a sample location 1010. The light collection apparatus 1001 includes an optical lens system 1020 having a plurality of lenses, The optical lens system 1020 includes a plurality of multiplet lenses on a side of the sample location 1010 located opposite of the mirror 1005 with respect to the sample location 1010 and at least one singlet lens located on a side of the sample location 1010 between the sample location 1010 and the mirror 105. The optical lens system 1020 includes six lenses 1020_1, 1020_2, 1021_1, 1021_2, 1021_3, 1021_4, with lenses 1021_1, 1021_2, 1021_3, 1021_4 being multiplet lenses.

The lens 1020_1 (which is a singlet) is located on the side of the sample location 1010 between the sample location 1010 and the mirror 1005. The lens 1021_1 is a doublet lens that is on the opposite side of the sample location 1010 from the lens 1020_1. The lenses 1020_1 and 1021_1 define the interrogation volume 1015. The lens 1021_2 is a triplet lens; the lens 1021_3 is a double lens; and the lens 1021_4 is a triplet lens. The lens 1020_2 (which is the last lens in the light collection apparatus 1001 in the path to the detection system 125) is a singlet.

The light collection apparatus 1001 also includes a chamber 1017 that defines the interrogation volume 1015. The sample 1035 is received at the sample location 1010 within the interrogation volume 1015. In some implementations, one or more walls 1019 of the chamber 1017 hold an immersion fluid 1018 in the interrogation volume 1015. The immersion fluid 1018 can be additionally partly contained by the lenses 1020_1 and 1021_1 of the optical lens system 1020. A flexible seal 1031 is formed between the chamber wall 1019 and the lens 1021_1 to permit some relative movement between the chamber wall 1019 and the lens 1021_1. The immersion fluid 1018 can have a refractive index between 1.0 and 1.7. The immersion fluid 1018 and the sample 1035 placed at the sample location 1010 can have the same refractive index.

The light collection apparatus 1001 can be implemented in the imaging apparatus 100 of FIG. 1. In such an arrangement, the imaging apparatus 100 is nominally diffraction limited, achromatic across the wavelength range 500-715 nanometers (nm), and, due to its diffraction limited numerical aperture of 1.0 and FOV of 12 mm diameter, has an etendue of 113 mm². With a nominal design (that is, no performance losses due to fabrication tolerances), the number of individually resolvable, imaged elements at the Abbe resolution limit would be 2.2×10⁹ at 510 nm.

In some implementations, the light collection apparatus 1001 is a custom-designed NA 1.0 mirror-based objective with a 12 mm field of view and a 25 mm working distance. The light collection apparatus 1001 can be designed for imaging media and samples with a refractive index between 1.33 and 1.34. The large field of view offers two advantages: (1) large samples 1035 up to 12 mm×12 mm×25 mm can be imaged without the need for physical sectioning or lateral sample translation, and (2) multiple cameras can be employed to image different parts of the sample 1035 simultaneously in order to improve imaging speed. The imaging apparatus 100 (in which any of the light collection apparatuses 101, 601, 701, 801, 1001 is implemented) is capable of imaging at a speed of 1.4×10¹⁰ voxels per second, which results in imaging a sample 1035 with physical dimensions 12 mm×8 mm×6 mm, corresponding to the average size of a mouse brain, within only two hours at a spatial resolution of 0.3 μm×0.3 μm×0.5 μm and using Nyquist sampling.

The imaging apparatus 100 in which the light collection apparatus 101, 601, 701, 801, or 1001 is implemented is a high numerical aperture, finite conjugate imaging system that transmits light from a probe image surface in the chamber 1017 (defined in the apparatus 1001 by the chamber wall 1019, and the lenses 1020_1 and 1021_1) filled with the immersion fluid 1018 to a detection image surface some distance away in the detection system 125. The probe image surface in the chamber 1017 is determined by the geometry of the one or more light beams 836 and is determined by the shape of the focal plane geometry. The probe image surface in the chamber 1017 can be a curved surface if the CABLE beams described below with reference to FIGS. 15-19 are used to produce the one or more light beams 836. The detection image surface in the detection system 125 is the image plane or planes in detector space that is conjugate to the focal plane in sample location 110. The detection image surface can be perfectly flat, or in other implementations, curved. An array of camera chips can be used to record the image at the image surface, and if the image surface is curved then a curved array of flat camera chips can be used.

In some implementations, the immersion fluid 1018 is water, or water with various salts and buffers, the NA is 1.0, the sample-side field of view is 12 mm in diameter, and the magnification is 35×, which results in a 420 mm diameter image surface. The light that is collected and imaged by the light collection apparatus 1001, upon exiting the sample 1035, first traverses the lens 1020_1 that forms one of the walls of the immersion fluid chamber, then crosses a small air gap before impinging upon the concave mirror 1005. The concave mirror 1005 provides a large proportion of the positive optical power of the light collection apparatus 1001, and is arranged nearly monocentrically with the system stop SS. Because of this near-monocentricity, the chief rays CR of the collected light 1026 have an angle-of-incidence on the mirror 1005 that is close to zero, and thus all field-dependent aberrations that result from the mirror 1005 are naturally small.

After reflecting from the mirror 1005, the imaged light 1026 traverses the lens 1020_1 again and reenters the interrogation volume 1015. Passing through in a reversed direction, some of the light 1026 is occluded by the sample 1035, or aberrated (in the case of a thin or highly transparent sample 1035). However, since the beam size of the light 1026 passing through the interrogation volume 1015 is large, the amount of light 1026 occluded by the sample 1035 is small. For example, in some implementations, less than 5%, less than 3%, less than 2%, or about 1.4% of the light that would be otherwise imaged is occluded by the sample 1035.

The imaged light 1026 then passes into the lens 1021_1, which forms another wall of the immersion chamber. After the lens 1021_1, the light traverses four more lenses 1021_2, 1021_3, 1021_4, and 1020_2, which serve to correct the wavefront and chromatic aberrations that the imaged light 1026 has already incurred. The light 1026 exiting the lens 1020_2 then proceeds toward the image surface of the detection system 125 within the imaging apparatus 100.

The presence of the immersion fluid chamber 1017, and the necessity of achromatizing the light collection apparatus 1001, can preclude the existence of a fully monocentric imaging solution, which in general has few positive power imaging solutions with an immersion liquid, and in general appears to lack the degrees of freedom necessary to eliminate axial color. The small deviations from monocentrism present in the mirror 1005, larger deviations in the lens 1020_1, and the large deviation in the immersed surface IS of the lens 1021_1 require the corrective action of lenses 1021_2, 1021_3, 1021_4, 1020_2, and the small deviation from monocentrism seen in the mirror 1005 itself is a result of simultaneously optimizing all of the optics together for aberration minimization, as is usually done during optical design.

The system stop SS in the light collection apparatus 1001 is located on a surface of lens 1021_2. In other implementations, a variable-size stop could be located near this location. An accessory window/filter 1022 is located near the system stop SS. The window 1022 could be used as an interference or absorption filter for unwanted light (such as excitation light in fluorescence microscopy).

As shown in FIG. 3, in some implementations, after exiting the lens 1020_2, the light 126 passes through an environmental window 322. The detection system 125 is highly sensitive to the refractive index of the immersion fluid 1018 due to the long path length of the imaging light through the immersion fluid 1018. Also, fluids such as water tend to experience much higher variability of refractive index with temperature. Therefore, the temperature and temperature gradients of the immersion fluid 1018 can be controlled, requiring that the optics within the detection system 125 be kept in a climate-controlled chamber (not shown in FIG. 3). The environmental window 322 separates the interior of this climate-controlled chamber from the exterior (outside lab space).

A second result of the sensitivity of the detection system 125 to the refractive index of the immersion fluid 1018 is that small changes in the composition of the immersion fluid 1018 can non-trivially affect the imaging performance at the detection system 125. Allowing some variability in the immersion fluid 1018 is desirable, as different sample preparations require different immersion compositions for optimal clearing and imaging performance. For example, different preparations of expanded tissue can be imaged optimally with varying amounts of phosphate or saline sodium citrate buffer present, which can raise the refractive index of water from 1.333 (at the d-line, 587 nm) to 1.343, and this change can be significant depending on the design of the detection system 125. To accommodate these changes in this design, the mirror 1005, the lenses 1021_1 and 1021_2 (as a set), and the lens 1021_3 are configured to move small amounts axially (along the imaging axis IA) depending on the composition of the immersion fluid 1018, allowing the recovery of diffraction limited performance through small changes in aberration balancing.

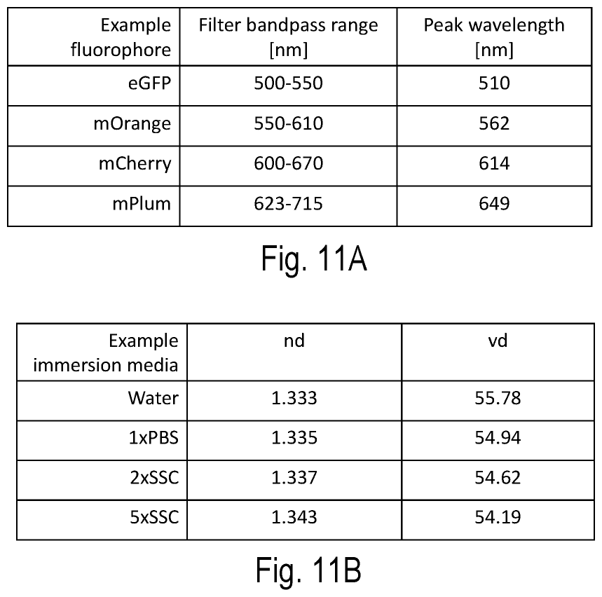

One imaging criterion that can be used to optimize the optical design of the light collection apparatus 1001 is the root-mean-squared optical path difference (RMS OPD) across several different variables. The first variable is the field position. The second variable is a fluorophore variable. Specifically, chromatic performance is evaluated separately over the weighted bandwidths of four different exemplary fluorophores: eGFP, mOrange, mCherry, and mPlum. FIG. 11A shows the simulated bandpass filter cutoff wavelengths used, and the peak emission wavelength of each fluorophore.

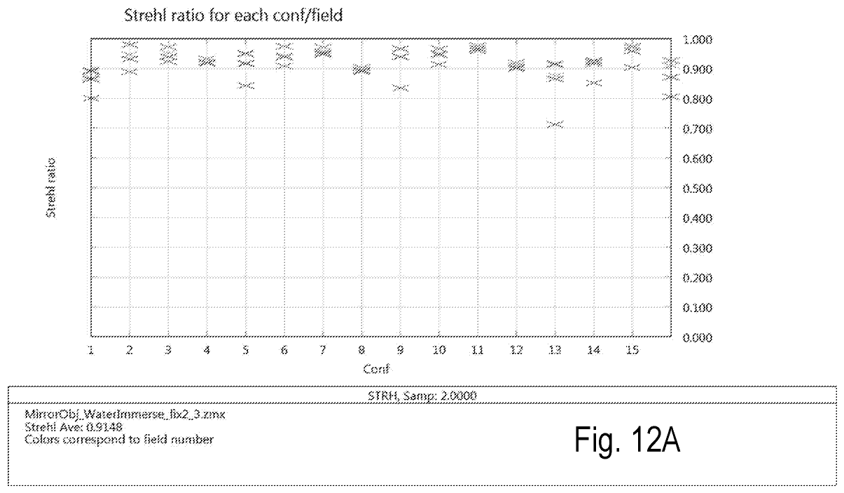

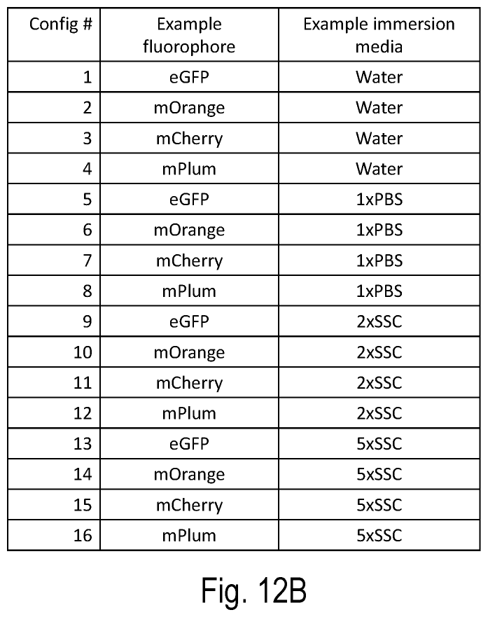

The third variable is the composition of the immersion fluid 1018 in which performance was evaluated using the refractive indices of different compositions for the immersion fluid 1018 such as water, phosphate buffered saline (1×PBS), and two different concentrations of saline sodium citrate buffer (2×SSC and 5×SSC). The refractive indices of these immersion fluids 1018 can be measured at a plurality (for example, 13) wavelengths in a wavelength range (such as a wavelength range 435-715 nm) using a custom-built refractometer with accuracy better than 0.0001. This data can be input into the optical design software Zemax OpticStudio to use these materials for optical design. FIG. 11B shows the refractive index and Abbe number values of these buffers at the d-line. Final evaluation of nominally built system performance can be made by calculating Huygens Strehl ratios under several imaging conditions using Zemax OpticStudio. FIGS. 12A and 12B show the results for the nominal system design. All Strehl ratios show performance at or above the customary 0.8 cutoff defining diffraction limited performance, except for the condition at 6 mm field, using eGFP, and 5×SSC imaging medium.

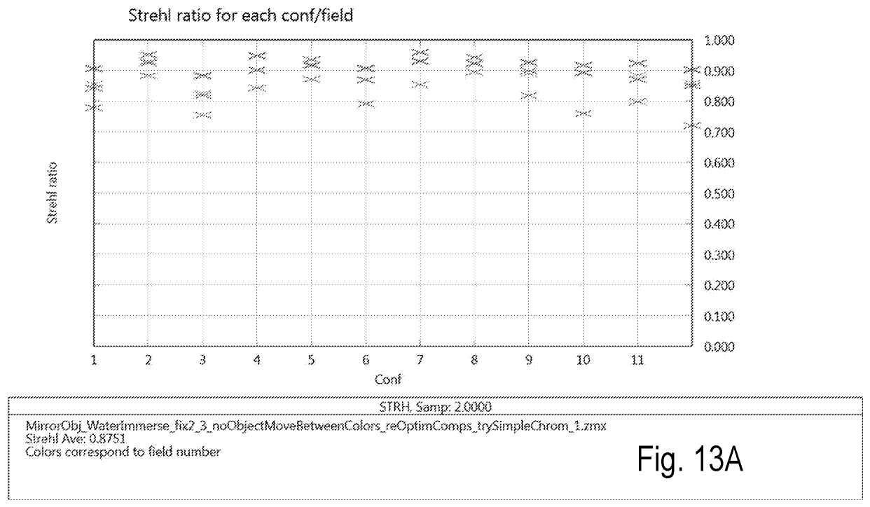

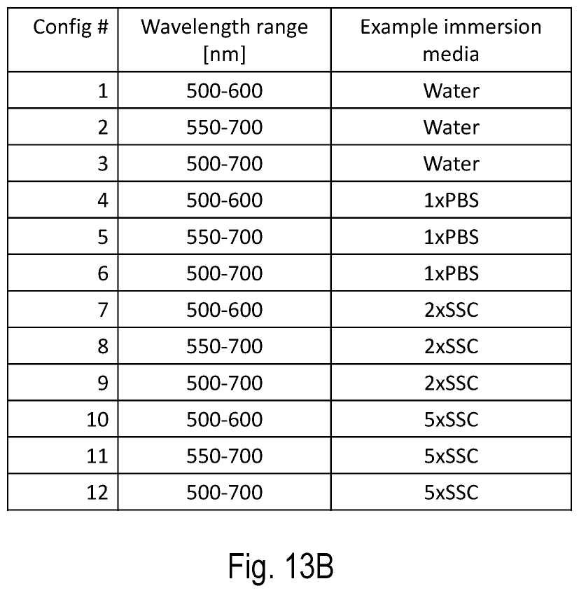

The axial positions of the mirror 1005, the lenses 1021_1 and 1021_2, and the lens 1021_3 are allowed to move between imaging media, but not between different fluorophores, meaning that simultaneous diffraction limited imaging with multiple fluorophores is possible, assuming that multiple excitation beams and cameras are chromatically multiplexed and used simultaneously. Although during optimization, different fluorophores are evaluated separately, the light collection apparatus 1001 can perform well across larger wavelength ranges that are weighted evenly. FIGS. 13A and 13B show the results under these wavelength conditions. Finally, although no optimization was performed at wavelengths under 500 nm, it was found that performance of the light collection apparatus 1001 at or near the diffraction limit is possible for fluorophores with emission wavelengths down to 435 nm, as long as the immersion fluid 1018 compensators (the mirror 1005, the lenses 1021_1 and 1021_2, and the lens 1021_3) are allowed to move to accommodate these wavelengths (vs. their positions at wavelengths 500-715 nm), and somewhat smaller bandpass widths are used (20-40 nm).

Referring to FIGS. 14A and 14B, an implementation 1430 of the sample apparatus 330 is shown. The sample apparatus 1430 is configured to maintain a sample 1435 at a sample location 1410 in an interrogation volume 1415 defined in a chamber 1417. The sample apparatus 1430 can include a sample holder 1437 in which the sample is fixed. The sample 1435, which can be a living specimen, or a chemically fixed, cleared and/or expanded specimen, is placed on or in the sample holder 1437. The interior of the chamber 1417 is filled with an immersion fluid 1418. The immersion fluid 1418 can have a refractive index between 1.33 and 1.34, and/or can match the refractive index of the sample 1435).

The sample apparatus 1430 also includes a positioning system 1438 to which the sample holder 1437 is fixed. The positioning system 1438 includes a motion (for example, a translation and/or rotation) stage 1439 fixed to the sample holder 1437, the motion stage 1439 configured to move the sample holder 1430 along a direction parallel with the X axis. The motion stage 1439 can also be configured to move the sample holder 1437 along one or more of the Y and Z axes or along a direction in the YZ plane, and/or rotate the sample holder 1437 about any of the X, Y, or Z axes. The positioning system 1438 (and motion stage 1439) can be in communication with the control system 455, to control the insertion of the sample holder 1437 (and the sample 1435) into the immersion fluid 1418, and position the sample 1435 relative to an imaging focal plane of the light collection apparatus 101.

The chamber 1417 is designed with optically transparent ports, to enable light to pass between the interrogation volume 1415 and the exterior of the chamber 1417. A port is placed at a first side Z1 relative to the sample location 1410, the port at the first side Z1 being adjacent to a mirror 1405 (which is an implementation of the mirror 105). A port is placed at a second side Z2 relative to the sample location 1410, the port at the second side Z2 being adjacent to the portion 1420p of the optical lens system 1420 that is positioned at the second side Z2.

An interrogation port 1433 is positioned on a side of the chamber 1417. The interrogation port 1433 provides an optical pathway for the one or more light beams 836 produced by the interrogation system 840 that are directed toward the sample 1435 at the sample location 1410 along a direction that is not parallel with (for example, is perpendicular to) the imaging axis IA. In these implementations, the light beams 836 travel to the sample location 1410 without interacting with the mirror 1405.

In the implementation discussed below in which the one or more light beams 836 are a set of 10 curved asymmetric Bessel-like excitation (CABLE) light beams IBo, the interrogation port 1433 is large enough to allow optical access to the sample 1435 for the CABLE beams IBo.

With reference again to FIG. 5, the interrogation system 540 includes the light apparatus 442 and the optical arrangement 544 that includes the CABLE beam generating system 545, the beam multiplexing system 546, the beam manipulation system 547, and the illumination arrangement 548 (which can include a custom tube lens and/or objective). An implementation 1540 of the interrogation system 540 is discussed next with respect to FIG. 15. The interrogation system 1540 is designed to produce or create a plurality (for example, ten) of curved light sheets as probes 836 directed to the sample at the sample location 110.

The interrogation system 1540 creates a curved asymmetric Bessel-like excitation (CABLE) beam, multiplexes the single beam into 10 beams arranged along a single axis, guides the 10 beams into the sample at the sample location 110, and scans the beams across the sample. The interrogation system 1540 includes the light apparatus 1542, which includes a light source that outputs laser light of different wavelengths as well as optics at the output of the light source, such optics expanding the light beam produced by the light source. The interrogation system 1540 includes a CABLE beam generation system 1545, a beam multiplexing system 1546, a beam manipulation system 1547, and an illumination arrangement 1548 including optics (such as a tube lens and objective) for guiding the beams into the sample at the sample location 110. Each of these aspects of the interrogation system 1540 is discussed next.

The light source within the light apparatus 1542 can be a high-power laser system (such as, for example, an HP Lightengine, by Omicron-Laserage, of Germany). The laser system includes a plurality (for example, six) individual high-power laser units, with each unit having a distinct wavelength. For example, the wavelengths can be, respectively, 488 nm, 532 nm, 560 nm, 592 nm, 631 nm, and 670 nm. The output laser power can be, for example, 500 mW for the 488 nm laser and 1000 mW for all other lasers. The intensity of each laser beam can be modulated by a respective, associated acousto-optic modulator (AOM). The light beams from the six lasers are combined using dichroic mirrors such that all laser beams leave the laser system through the same output port. The output light beam from the laser system can be coupled into a high-power optical fiber. After leaving the optical fiber, the beam is collimated and expanded by a collimator and beam expander before being provided to the CABLE beam generation system 1545.

A CABLE beam can be created by the CABLE beam generation system 1545. A CABLE beam has a curved trajectory that matches a curvature of the focal plane of the objective of the light collection apparatus 101 (determined by the mirror 105). A CABLE beam is both very long (700 μm) and very thin (0.6 μm) (taken at the central peak of the CABLE beam), allowing high-resolution imaging while taking full advantage of an imaging area within the detection system 125 (for example, sCMOS cameras that can be used in the detection system 125 have a large chip size.

The Bessel-like light-sheet illumination scheme can be accompanied by a disadvantage. Side lobes of the Bessel-like beam can produce a pronounced fluorescence background that significantly decreases image contrast. To solve this problem, a method for creating asymmetric Bessel-like beams with suppressed side lobes along a specified direction is performed, as discussed next.

Referring to FIG. 16A, the CABLE beam generation system 1545 includes a spatial light modulator 1660, a pair of achromatic lenses (first lens 1661 and second 1662) that form a 4-f system, a ring aperture 1663 located at a front focal plane of the first lens 1661, and a mirror 1664 that redirects the light from the spatial light modulator 1660 to the first lens 1661. The spatial light modulator 1660 can be a phase-only spatial light modulator (such as, for example, SLM, MSP1920-0635-HSP8, by Meadowlark). A phase pattern is applied by the spatial light modulator 1660. The laser beam is directed to the spatial light modulator 1660, and is diffracted on its path to the first lens 1661 (by way of the mirror 1664). Then, the light is filtered by the ring aperture 1663, which only transmits light within the ring geometry. The light then forms a CABLE beam after passing through the second lens 1662.

Specifically, and with reference to FIG. 16B, the phase pattern applied to the spatial light modulator 1660 acts as a mask 1660m that is composed of two opposing triangles with tip angle θ is applied to the phase pattern that generates the curved Bessel-like beam. After applying the mask 1660m, light that is reflected from the masked area of the spatial light modulator 1660 is focused to a single spot 1663s at the location of the aperture 1663 by the first lens 1661, while diffracted light originating from the unmasked area of the spatial light modulator 1660 is focused to a ring pattern 1663r by the first lens 1661. The ring aperture 1663 blocks light from the masked area of the spatial light modulator 1660 and transmits light from the unmasked area of the spatial light modulator 1660. After passing the second lens 1662, the light forms a CABLE beam with directionally suppressed side lobes.

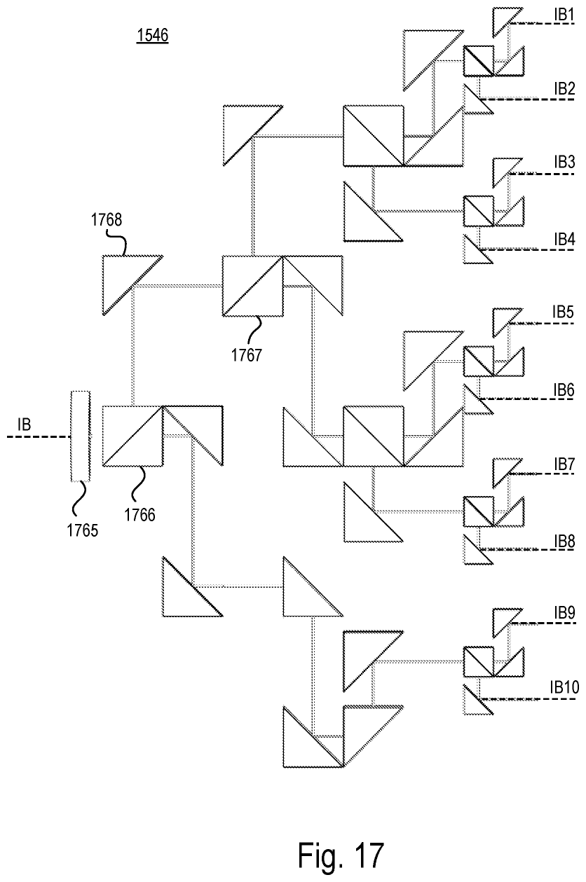

Referring to FIG. 17, the beam multiplexing system 1546 consists of an achromatic half wave plate 1765, a polarization-sensitive beam splitter (PBS) 1766, multiple non-polarizing 50:50 beam splitters (one of which is labeled as 1767), and a plurality of mirrors (one of which is labeled as 1768). These optical components are arranged such that they split one illumination beam IB into 10 illumination beams IBo (where o is an integer from 1 to 10) that are of equal intensity and equally spaced along a single row. Furthermore, each beam travels the same distance in glass and air, and thus the wave fronts of the beams IBo are located within the same plane when exiting the multiplexing system.

As shown in FIG. 17, the polarized laser beam IB first passes through the achromatic half wave plate 1765, followed by the PBS 1766. By rotating the half wave plate 1765, the intensities of the two output beams produced by the PBS 1766 can be matched. After the beam is split in two by the PBS 1766, three mirrors 1768 are arranged around the PBS 1766 to direct both beams in the forward direction while keeping their optical path lengths identical. Each beam then enters the next splitting stage. For the upper beam emerging from the first splitting stage (relative to the plane of the drawing in FIG. 17), a 50:50 beam splitter 1767 is used to split the beam into two beams of equal intensity. Three mirrors 1768 are arranged around the beam splitter 1767 to direct the beams in the forward direction while maintaining identical optical path lengths for all beams. The split beams then proceed to the next two splitting stages, which utilize a similar optical architecture. The beam splitters 1767 and mirrors 1768 of the last stage are smaller than those of the previous stages such that the distance between beams can be maintained. This geometry enables the production of a large number of illumination beams (in this case, ten) within the field of view of the interrogation system 440 and the imaging apparatus 400. Specifically, the illumination beams are within the field of view of the objectives in the interrogation system 440 and the imaging apparatus 400 (such as the mirror 105 and the illumination arrangement 1548) at the same time. For the lower beam emerging from the first splitting stage (relative to the plane of the drawing FIG. 17), the mirrors 1768 and beam splitters 1767 are arranged such that the beams travel the same distance in air and glass as their counterparts from the upper portion of the splitting system.

Referring to FIGS. 18A and 18B, the beam manipulation system 1547 is made up of 10 beam manipulation sub-systems 1870-o, where o is an integer from 1 to 10. Each beam manipulation sub-system 1870-o receives a respective illumination beam IBo from the beam multiplexing system 1546. This array of sub-systems 1870-o is used to scan the 10 beams IBo, and place the beams IBo on a curved surface that matches the curvature of the objective focal plane.

Referring to FIG. 18C, each sub-system 1870-o consists of two lenses 1871a, 1871b, and two galvanometer scanners, a first dual-axis galvanometer scanner GSa and a second dual-axis galvanometer scanner GSb. The first dual-axis galvanometer scanner GSa includes a galvanometer scanner GSax (arranged along an x axis) and a galvanometer scanner GSay (arranged along a y axis); and the second galvanometer scanner GSb includes a galvanometer scanner GSbx (arranged along an x axis) and a galvanometer scanner GSby (arranged along a y axis). Each dual-axis galvanometer scanner GS can be, for example, a model 6SD12380 or 6SD12381 from Cambridge Technology. The illumination beam IBo is first pivoted by the first dual-axis galvanometer scanner GSa. The first lens 1871a is placed after the first dual-axis galvanometer scanner GSa such that the back focal plane of the first lens 1871a is located at the geometrical center between the x and y scan mirrors of the first dual-axis galvanometer scanner GSa. The second dual-axis galvanometer scanner GSb is positioned such that the front focal plane of the first lens 1871a coincides with the center of they scan mirror of the second dual-axis galvanometer scanner GSb. The second lens 1871b is placed after the second dual-axis galvanometer scanner GSb such that the back focal plane of the second lens 1871b coincides with the center of they scan mirror of the second dual-axis galvanometer scanner GSb. The second lens 1871b thus translates the pivoting beam motion produced by the second dual-axis galvanometer scanner GSb into lateral and axial beam shifts.

Referring back to FIGS. 18A and 18B, ten (10) identical beam manipulation sub-systems 1870-o are placed side-by-side. The relative spacing between the sub-systems 1870-o can be less than 5 centimeters, for example, about 25 millimeter (mm), in order to create the complete beam manipulation system 1547 for manipulating the 10 illumination beams IBo. To ensure that the 10 beams IBo are all located on the curved focal plane of the detection objective (that is, the mirror 105), the x scan mirrors in the respective second dual-axis galvanometer scanner GSb in each beam manipulation sub-system 1870-o are rotated to a specific angle that shifts the beams IBo upward by the distance required for positioning each beam on the curved focal plane.

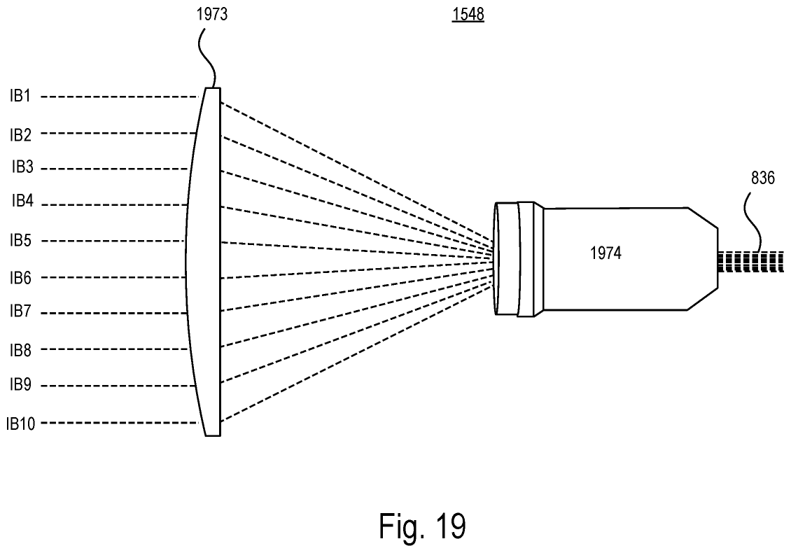

Referring to FIG. 19, the illumination arrangement 1548 includes a custom tube lens 1973 and a custom interrogation objective 1974 that, in combination, image the 10 illumination beams IBo onto the sample at the sample location 110. The output of the illumination arrangement 1548 is the one or more probes (or one or more light beams) 836 (as shown, for example, in FIGS. 9A and 9B). The interrogation objective 1974 is designed to provide diffraction-limited performance within the ring aperture 1663r associated with the CABLE beams. The interrogation objective 1974 can, in some implementations, have an NA of 0.4, a field of view of 12 mm, and a working distance of 90 mm.

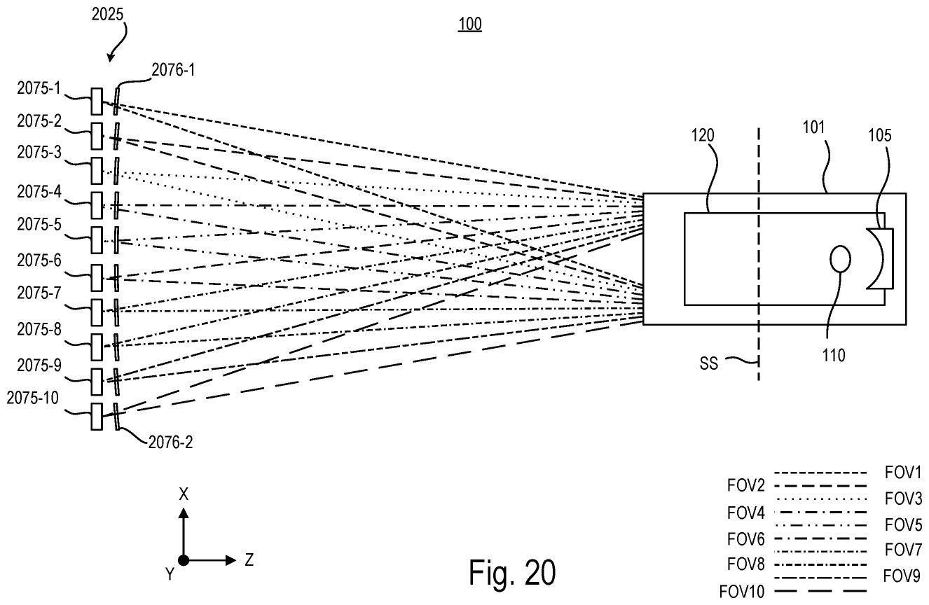

Referring to FIG. 20, in some implementations, the image field (at the detection system 125) can be broken up into sub-FOVs (FOV-o, where o is an integer from 1 to 10), to provide imaging by multiple digital imaging sensors. The detection system 2025 of FIG. 20 includes 10 cameras 2075-o, where o is an integer from 1 to 10, the cameras 2075o spread along a plane or line in the x-dimension from one end of the FOV to the other, with the total width of all the imaging chips being slightly greater than one-third the width of the full FOV. Each of the cameras 2075-0 images a field illuminated by one CABLE beam IBo, and each camera 2075-o has a corresponding emission filter 2076-o, where o is an integer from 1 to 10. Each emission filter 2076-o is rotated differently from the others such that the angle-of-incidence of the light across each sub-FOV is minimized or reduced as much as possible on each filter 2076-o.

In three dimensions, the camera array 2075-o can be split into three sections using fold mirrors to allow the proper sub-FOV spacing when using the commercially available cameras, which have a large ratio of housing width to imaging chip width.

The optically useable total detection FOV that is covered by the imaging sensors at the cameras 2075o in the design shown in FIG. 20 can be a fraction of the FOV of the whole detection system 2025. For example, the usable total detection FOV from all the cameras 2075o can be 2-5% of the FOV of the whole detection system 2025. Different illumination schemes and/or more economical and efficiently (likely custom) packaged imaging sensors can allow using substantially more of the available detection FOV.

With reference again to FIGS. 14A and 14B, the optical microscope 450 and the imaging apparatus 100 can be used for imaging a wide variety of samples or specimens 1435. A specimen that is relatively clear and has a refractive index between 1.33 and 1.34 can generally provide exceptional image quality. An example of a biological sample in this domain is expanded biological tissue (using the Expansion Microscopy protocol), such as an expanded section of a mouse brain. After expansion, the brain or brain section is attached to the sample holder 1437. In some implementations, the interrogation volume 1415 is filled with a clear aqueous solution (as the immersion fluid 1418) suitable for imaging expanded samples 1435. The sample 1435 is lowered into the immersion fluid 1418 and positioned relative to the imaging focal plane of the mirror 1405 using an x translation stage.

Before acquiring images, and referring again to FIGS. 4, the optical microscope 450 can be tuned to work optimally with the sample 1435 and immersion fluid 1418 by optimizing the locations and angles of the probe beams 836 (FIGS. 9A and 9B) relative to the sample location 1410, and adapting the optics to the exact refractive index of the immersion fluid 1418 in the imaging chamber 1417. To optimize the locations and angles of the probe beams 836, images are acquired by the detection system 125, and quality metrics associated with these images can be computed and evaluated. Based on these measurements, the optimal offset voltages for the pivot and scan galvanometer scanners GSa, GSb can be calculated and applied. This process can be repeated until image quality is considered optimal (or within an acceptable range of values). Similarly, to adapt to the refractive index of the immersion fluid 1418 in the imaging chamber 1417, images can be acquired by the detection system 125, and quality metrics associated with these images can be computed and evaluated. Based on these measurements, optimal offset positions for the translation stages attached to the lens groups (the lenses) in the optical lens system 120 are calculated and then applied. The process can be repeated until image quality is considered optimal (or within an acceptable range).

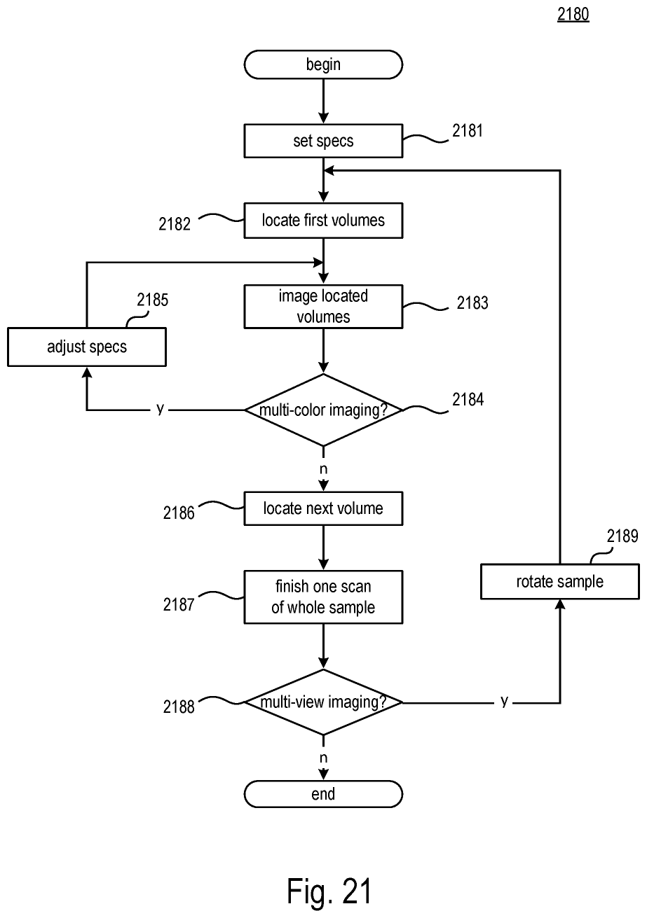

Referring to FIG. 21, a procedure 2180 can be performed by the optical microscope 450 of FIG. 4, using any one of the imaging apparatuses 100, 300, 400, 600, 700, 800 and/or interrogation system 440.

When turning on the optical microscope 450, an initialization step can be initially executed on the master control apparatus 456 to establish communication between the master control apparatus 456 and other electronics within the microscope, including, for example, the spatial light modulator 1660 (FIG. 16A), translation and/or rotation stages (such as the motion stage 1439 or the translation/rotation stages TRS1, TRS2, TRS3), and filter wheels (such as those that can be used in the filter array FA, and can be placed in the imaging apparatus 100). The translation and/or rotation stages and filter wheels/filter arrays FA can be initially set to their home positions during the initialization step. An initialization step is also executed on the data acquisition nodes to establish communication between these nodes and their associated cameras. The one or more cameras in the detection system 125 are initialized with default acquisition parameters. After initialization, the optical microscope 450 is ready to operate.

The procedure 2180 describes the imaging acquisition workflow of the optical microscope 450, based on the implementation of the interrogation system 1540. A whole sample 735, 835, 1035, 1435 can be imaged by iterative acquisition of sub-volumes within the sample. The size of each sub-volume can be defined by the size of the camera chip and the magnification of the detection optics within the imaging apparatus 100. In one specific implementation, the size of each sub-volume is 408 μm×723 μm×Σ μm. The parameter Σ is flexible (within the working distance of the detection optics) and determined by a user. Using 10 cameras (such as shown in the implementation of FIG. 20, 10 sub-volumes can be acquired simultaneously.

To start image acquisition, the specifications of the optical microscope 450 are set (2181). For example, the requested laser line or color is activated in the interrogation system 1540, the corresponding emission filters are rotated into position by the filter wheels FA, and the spatial light modulator 1660 is updated with a corresponding phase pattern. The laser beam with the desired excitation wavelength is turned on. Collimated laser light is expanded and transformed to a CABLE beam IBo by the CABLE beam generation system 1545. The curvature of the CABLE beam IBo is adjusted to match the curvature of the focal plane of the detection objective (the mirror 105). The IBo beam is then split into 10 beams, which have matched intensities and are arranged along a single row, by the beam multiplexing system 1546. The split beams are positioned by the beam manipulation system 1547 onto a curved surface with a curvature that matches the curvature of the focal plane of the detection objective (the mirror 105). The beams IBo are guided into the sample and scanned within the curved focal plane to create 10 curved light sheets.

The 10 illumination beams IBo/836 are moved to their respective starting locations (2182), and then the beams IBo/836 are scanned using a saw tooth input waveform with a repetition rate of 120 Hz (matched to the frame rate of the cameras in the detection system 125). Meanwhile, the sample is translated at a constant speed using the z stage, and images are acquired at the same time (2183). For example, the emitted fluorescence light is collected by the detection objective 105 and filtered by the appropriate fluorescence filters 2076-o in front of each camera 2075-o to eliminate laser light (the light from the probes 836) and keep only the fluorescence light. The cameras are operated in light-sheet mode, such that the line propagation speed of the active area that is scanned across the camera chip matches the scan speed of the illumination beams IBo. The images captured by the cameras 2075-o are sent to their corresponding image acquisition nodes for storage and post-processing.

If multi-color imaging is desired (2184), then the specifications are adjusted (2185). In particular, the currently active laser line or color is disabled, the next required laser line or color is activated, and one or more filter wheels are rotated to thereby switch filters to correspond to the active laser line. The phase pattern at the spatial light modulator 1660 is updated accordingly, and the same set of sub-volumes is imaged again (2183). When imaging of the 10 sub-volumes is finished, the sample 735, 835, 1035, 1435 is translated along x, y, or z (2186) to image the next set of 10 sub-volumes (2183). This procedure continues until the volume of the entire sample 735, 835, 1035, 1435 has been imaged (2187). If multi-view imaging is desired (2188), the sample 735, 835, 1035, 1435 is rotated by a specified angle using the rotation stage (2189), and the imaging process is repeated at step 2182.

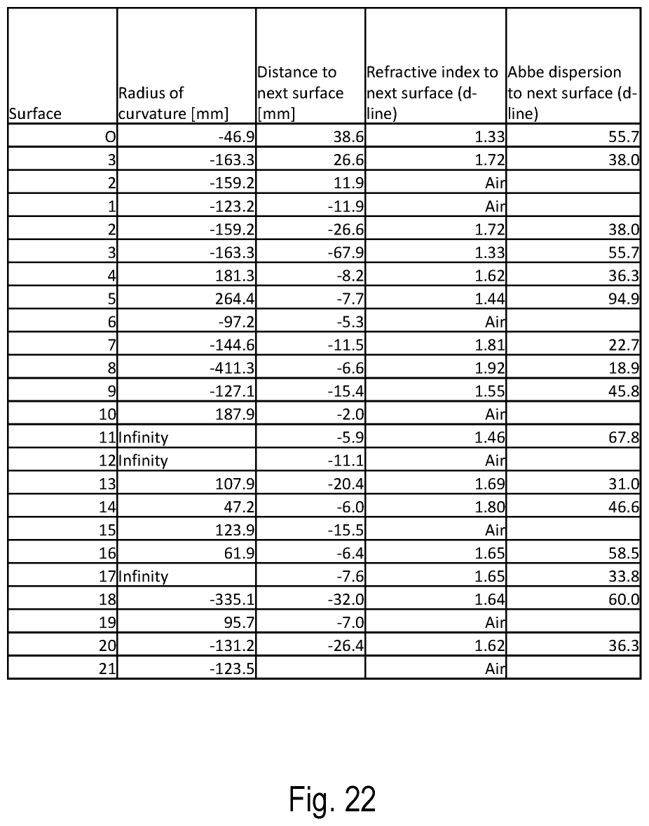

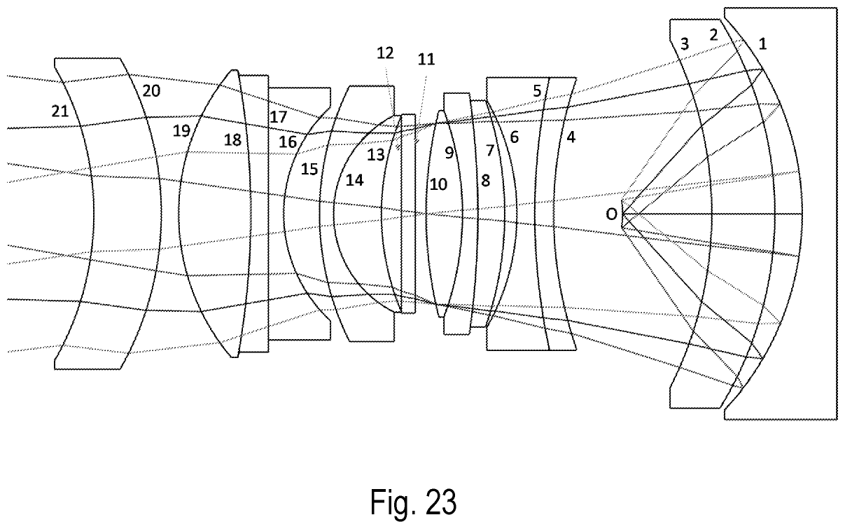

FIG. 22 provides an example optical prescription, in which labels of the optical surfaces are given in FIG. 23, and positive axial direction is toward the right on the page.

For volumetric image acquisition, the sample is translated by the z-stage at a constant speed. For multi-color imaging, the active laser beam is switched to a different color by deactivating the first laser beam and activating a laser unit emitting a different wavelength, the corresponding fluorescence filter is selected by the filter wheel, and a phase pattern on the spatial light modulator 1660 is adjusted accordingly (FIG. 16A). Then the same sample volume is imaged again using the second laser wavelength by translating the z-stage. Alternatively, laser beams can be switched for each image plane such that the sample volume is only scanned once along the z-axis. Optionally, multi-view image acquisition is facilitated by rotating the sample to a different orientation with the rotation stage and re-imaging the sample volume after the acquisition of one view of the sample volume is complete.

1. An imaging apparatus comprising:
a mirror positioned along an imaging axis that passes through a sample location within an interrogation volume;
an optical lens system comprising a plurality of optical lenses arranged along the imaging axis, at least one of the optical lenses being a multiplet optical lens; and
a detection system external to the interrogation volume and configured to detect light emitted from the sample location and collected by the mirror and the optical lens system.

2. The imaging apparatus of claim 1, wherein the optical lenses of the optical lens system are arranged so that, over every optical surface, all light rays in normal operation have a maximum exit angle in air, with respect to the lens surface normals, within a range of 35°-40°.

3. The imaging apparatus of claim 1, wherein the detection system images the light emitted from the sample location at the diffraction limit of the numerical aperture of the light detection system.

4-6. (canceled)

7. The imaging apparatus of claim 1, wherein:
the mirror and the optical lens system make up a light collection apparatus that is diffraction-limited and has a field of view of at least 8 millimeters, at least 10 millimeters, or at least 12 millimeters in diameter; and/or
the mirror and the optical lens system make up a light collection apparatus that is diffraction-limited and has an etendue of at least 100 square millimeters.

8. The imaging apparatus of claim 1, wherein the mirror and the optical lens system make up a light collection apparatus that is diffraction limited; a working distance between the sample location and an element of the optical lens system or the mirror is at least 20 millimeters; and each of the mirror and the optical lenses in the optical lens system is spherical.

9. The imaging apparatus of claim 1, wherein the mirror and the optical lens system make up a light collection apparatus having a numerical aperture of at least 0.8, at least 0.9, or at least 1.0 for a field of view of at least 8 millimeters, at least 10 millimeters, or at least 12 millimeters in diameter for light emitted from the sample location having a wavelength within the range of 400-800 nanometers.

10. The imaging apparatus of claim 1, wherein the mirror and the optical lens system make up a light collection apparatus that is diffraction-limited for light having a wavelength within the range of 500-800 nanometers at 81-90% light transmission efficiency.

11. The imaging apparatus of claim 1, wherein the mirror and the optical lens system make up a light collection apparatus that is simultaneously achromatic across a range of wavelengths of 500-700 nanometers, a range of wavelengths of 700-800 nanometers, or a range of wavelengths of 450-500 nanometers.

12. (canceled)

13. The imaging apparatus of claim 1, wherein the optical lens system comprises a plurality of singlet optical lenses, a plurality of doublet optical lenses, and at least one triplet optical lens.

14. The imaging apparatus of claim 1, wherein the mirror is a mirror that is monocentric with an image of a surface of the sample location, and a maximum angle of incidence of a chief ray of light onto the optical surface of the mirror at a full field of view is 2°, 3°, or 4°.

15. The imaging apparatus of claim 1, wherein the mirror and the optical lens system make up a light collection apparatus configured to reduce field dependent aberrations to below a root mean square wavefront error of 0.09 waves.

16. The imaging apparatus of claim 1, wherein the optical lens system comprises a plurality of multiplet lenses on a side of the sample location opposite the mirror and at least one singlet lens on a side of the sample location between the sample location and the mirror.

17. (canceled)

18. The imaging apparatus of claim 1, wherein each of the optical lenses of the optical lens system and the mirror is spherical, and the axial positions of one or more of the optical lenses of the optical lens system are offset to thereby adjust for aberrations caused by variations in the refractive index of a sample at the sample location.

19. (canceled)

20. The imaging apparatus of claim 1, wherein:
the mirror and the optical lens system make up a light collection apparatus configured to provide an optically accessible sample location along a direction perpendicular to the imaging axis; and
the light collection apparatus has a working distance and a curvature of each of the optical lenses located on either side of a sample at the sample location that provides optical access to the sample location at a numerical aperture of at least 0.4, at least 0.5, or at least 0.6 to a surface of the sample at the sample location.

21. (canceled)

22. An imaging apparatus for imaging a sample, the imaging apparatus comprising:
a mirror positioned along an imaging axis that passes through a sample location; and
an optical lens system comprising a plurality of optical lenses arranged along the imaging axis, at least one of the optical lenses being a multiplet optical lens;
wherein the mirror and the optical lenses in the optical lens system are located on both sides of the sample location along the imaging axis.

23. The imaging apparatus of claim 22, wherein the optical lenses of the optical lens system are arranged so that light has a maximum angle of exitance, in air, over every optical surface, within a range of 35°-40°.

24. A detection apparatus for imaging a sample, the detection apparatus comprising:
a mirror positioned along an imaging axis that passes through a sample location;
an optical lens system comprising a plurality of optical lenses arranged along the imaging axis, at least one of the optical lenses being a multiplet optical lens; and
a sample apparatus configured to define an interrogation volume and receive the sample at the sample location within the interrogation volume, the sample apparatus including an immersion fluid at least partly contained by one or more optical lenses of the optical lens system;
wherein the mirror and the optical lenses in the optical lens system are located on both sides of the sample location.

25-27. (canceled)

28. An optical microscope apparatus comprising:
an optical interrogation system configured to probe a sample location including producing one or more light beams directed toward the sample location; and
a light collection system configured to collect light output from a sample due to being probed by the sample interrogation system, the light collection system comprising:
a mirror positioned along an imaging axis that passes through the sample location; and
an optical lens system comprising a plurality of optical lenses arranged along the imaging axis, at least one of the lenses being a multiplet optical lens.

29. (canceled)

30. The optical microscope apparatus of claim 29, wherein:
the one or more light beams produced by the optical interrogation system are directed toward the sample location by way of the mirror; or
the one or more light beams produced by the optical interrogation system are directed toward the sample location along a direction perpendicular to the imaging axis without interaction with the mirror.

31. (canceled)

32. (canceled)

33. The optical microscope apparatus of claim 28, further comprising a detection system that is configured to receive the light collected from the light collection system, the speed at which the detection system acquires data is at least 1.0×10¹⁰ voxels per second.

34-37. (canceled)

38. The optical microscope apparatus of claim 28, further comprising:
a control system in communication with the sample interrogation system and the light collection system, and configured to coordinate electrical and optical properties of the sample interrogation system and the light collection system; and
a detection system that is configured to receive the light collected from the light collection system, wherein the control system is in communication with the detection system and is configured to form an image of a sample from the light collected from the light collection system due to the sample being probed by the sample interrogation system.

39. (canceled)
